(19) United States
(12) Patent Application Publication
(10) Pub. No.: US 2025/0375950 A1
(43) Pub. Date: Dec. 11, 2025

(54) ARTICLE WITH PRESSURE MANAGEMENT AND THERMAL INSULATION PROPERTIES

(71) Applicant: 3M INNOVATIVE PROPERTIES COMPANY, St. Paul, MN (US)

(72) Inventors: Kazuhiko Mizuno, Tokyo (JP); Claus H.G. Middendorf, Neuss (DE); Pierre Reinhard Bieber, Korschenbroich (DE); Shailendra B. Rathod, St. Paul, MN (US); Jeffrey P. Kalish, Woodbury, MN (US); Thomas Apeldorn, Moenchengladbach (DE); Roman Konietzny, Schwalmtal (DE); Tom Gaide, Koeln (DE); Petra M. Stegmaier, Duesseldorf (DE); Simon Plugge, Duesseldorf (DE); Sascha Sprott, Essen (DE); Margaret M. Vogel-Martin; Michael Kempf, Neuss (DE)

(21) Appl. No.: 18/875,980

(22) PCT Filed: Jun. 20, 2023
(86) PCT No.: PCT/IB2023/056382

§ 371 Date: Dec. 17, 2024

Related U.S. Application Data
(60) Provisional application No. 63/354,167, filed on Jun. 21, 2022.
(60) Provisional application No. 63/371,965, filed on Aug. 19, 2022.

(51) Int. Cl. B32B 5/02; B32B 5/18; B32B 5/24

(52) U.S. Cl. CPC B32B 5/022; B32B 5/18; B32B 5/245; B32B 2250/03; B32B 2250/40; B32B 2260/021; B32B 2260/04; B32B 2262/10; B32B 2266/0214; B32B 2266/0292; B32B 2307/304; B32B 2307/552; B32B 2457/10

(57) ABSTRACT

The present disclosure relates generally to the field of cushioning articles, more specifically to the field of articles having pressure management and thermal insulation properties. The present disclosure also relates to a method of manufacturing such articles and to their use for industrial applications for pressure and thermal management applications.

### TECHNICAL FIELD

The present disclosure relates generally to the field of cushioning articles, more specifically to the field of articles having pressure management and thermal insulation properties. The present disclosure also relates to a method of manufacturing such articles and to their use for industrial applications for pressure and thermal management applications.

### BACKGROUND

Automotive electrification is currently one of the biggest trends in the automotive industry. Within this trend, the propulsion of electric energy supplied by electric batteries and the development of suitable electric vehicle batteries as energy storage devices are the main focus in the automotive industry. Electric-vehicle batteries are used to power the propulsion system of battery electric vehicles (BEVs) and hybrid electric vehicles (HEVs). These batteries, which are typically lithium-ion batteries, are designed with a high ampere hour capacity. The trend in the development of electric vehicle batteries goes to higher energy density in the battery (kWh/kg) to allow the covering of longer distances and to reducing charging times of the battery.

Due to the high energy density of electric vehicle batteries and the high energy flow during charging or discharging of the battery, there is a risk of creation of hot spots and thermal runaway events where the heat generated by the decomposition of battery cells propagates very rapidly to neighboring cells. This chain reaction might lead to the explosion or the fire catching of the whole electric vehicle.

Moreover, during the normal life cycle of these energy storage devices, in particular during fast charging and discharging cycles of electric vehicle batteries, the battery cells used for such battery modules tend to expand and retract continuously. These expansion/contraction cycles can put the battery cells under considerable pressure conditions, which in turn may lead to not only mechanical damage of the battery cells, but also to complete failure of the battery module.

In that context, the use of thermal management solutions has rapidly emerged as one way the mitigate the temperature rise in battery assemblies. Various partial solutions are known. See, e.g., US-A1-2007/0259258, US-A1-2019393574, and US-A1-2016/0308186.

### SUMMARY

In a general embodiment, the disclosure is directed to multilayer thermal barriers, comprising:
one or more thermally-insulating porous foam layers,
one or more thermally resistant layers disposed on the thermally-insulating porous foam layer,
   wherein a thermally-insulating porous foam layer alternates with a thermally resistant layer,
   wherein the thermally resistant layers comprise insulative particles,
   wherein the multilayer thermal barrier exhibits a pressure of at least 30 kPa when subjected to a compression of 20%,
   wherein the multilayer thermal barrier exhibits a pressure of less than 2,500 kPa when subjected to a compression of 55%, and
   wherein a cold plate takes more than 500 seconds to reach 150° C. in a HCST test.

In certain embodiments, the weight ratio of thermally-insulating porous foam layers to thermally resistant layers in the multilayer thermal barriers is from 20%-75% in the multilayer thermal barrier.

In other embodiments, the multilayer thermal barrier does not have the following 3-layer construction:
a first thermally resistant layer,
a thermally-insulating porous foam layer immediately adjacent to the first thermally resistant layer, and
a second thermally resistant layer immediately adjacent to the thermally-insulating porous foam layer.

In yet other embodiments, the multilayer thermal barrier has the following 3-layer construction:
a first thermally resistant layer,
a thermally-insulating porous foam layer immediately adjacent to the first thermally resistant layer, and
a second thermally resistant layer immediately adjacent to the thermally-insulating porous foam layer.

### BRIEF DESCRIPTION OF THE DRAWINGS

FIG. 1—A multilayer thermal barrier (100) containing a thermally insulating porous foam layer (101) and one or more thermally resistant layers (102). Optionally, encapsulated with an organic polymeric layer (106).

FIG. 2—A battery module 200 includes an assembly of battery cells 202. One or more multilayer thermal barriers 201, formed from the exemplary materials described herein, can be disposed between individual battery cells or groups of cells at one or more locations throughout the battery module.

FIG. 3—A battery pack 300 includes a plurality of battery modules 302. A series of multilayer thermal barriers 301, formed from the exemplary materials described herein, are provided to be placed between adjacent battery modules or placed on the top of the battery modules 302. The black rectangle represents the placement of a multilayer thermal barrier on top of a battery module. Alternatively, multilayer thermal barriers can be placed in between one or more battery packs and the walls of the battery pack container (not shown).

FIG. 4—A manufacturing process to assemble thermally-resistant layers (102) of the multilayer thermal barrier (100).

FIG. 5—A manufacturing process to assemble thermally insulating porous foam layers (101) of the multilayer thermal barrier (100).

FIG. 6—A schematic representation of a mechanical cycling test.

FIG. 7—A schematic representation of results from the compression test on various comparative examples. See Table 5.

FIG. 8—A schematic representation of results from the compression test on various working examples. See Table 5.

FIG. 9—A schematic representation of results from the HCST test on various comparative examples. See Table 5.

FIG. 10—A schematic representation of results from the HCST test on various working examples. See Table 5.

### DETAILED DESCRIPTION

According to a first aspect, the present disclosure relates to a multilayer thermal barrier comprising:
one or more thermally-insulating porous foam layers,
one or more thermally resistant layers disposed on the thermally-insulating porous foam layer,
wherein a thermally-insulating porous foam layer alternates with a thermally resistant layer,
wherein the thermally resistant layers comprise insulative particles,
wherein the multilayer thermal barrier exhibits a pressure of at least 30 kPa when subjected to a compression of 20%,
wherein the multilayer thermal barrier exhibits a pressure of less than 2,500 kPa when subjected to a compression of 55%, and
wherein a cold plate takes more than 500 seconds to reach 150° C. in a HCST2 test.

In the context of the present disclosure, it has been surprisingly found that a multilayer thermal barrier as described above has excellent thermal insulation properties, excellent thermal runaway barrier performance, and excellent compressibility and pressure management characteristics. In some advantageous aspects, the multilayer construction as described above further displays excellent heat resistance and stability even at temperatures up to 600° C. and prolonged exposure to heat.

The described multilayer construction is further characterized by one or more of the following advantageous benefits: a) excellent cushioning performance towards individual battery cells when used in battery assemblies; b) excellent resistance to high compression forces and high-pressure conditions throughout the lifetime of a battery assembly; c) ability to maintain a foam structure for the polymeric foam layer even under high-pressure conditions; d) easy and cost-effective manufacturing method, based on readily available starting materials and minimized manufacturing steps; e) construction simplicity and versatility; f) excellent formulation flexibility of the polymeric foam layer for use herein; g) excellent construction and design flexibility of the spacer layer into various forms, sizes and shapes; h) ability to fine-tune the compression characteristics of the multilayer construction to specific applications, operating conditions and battery cell types; i) excellent pressure distribution towards individual battery cells when used in battery assemblies; j) excellent processability and converting characteristics; k) low thermal conductivity; 1) ability to be produced in relatively low thicknesses; m) ready-to-use article in particular for thermal management applications; n) prolonged durability of the energy storage assemblies using the cushioning article of the disclosure; and o) ability to adhere to various substrates such as metallic or polymeric surfaces without requiring adhesion-promoting processing steps or compositions.

Those are particularly unexpected findings for various reasons. Firstly, good cushioning performance and resistance to high compression forces and high-pressure conditions are believed to be self-contradicting properties. Also, thermal insulation and heat resistance stability are usually not expected to be obtained with compressible (soft) porous foam layers, in particular foam layers having a relatively low thickness, and more in particular with compression applied.

In the context of the present disclosure, the inventors were faced with the technical challenge of designing a multilayer thermal barrier construction provided with a delicate balance of excellent compressibility characteristics, resistance to high compression forces, and thermal insulation properties.

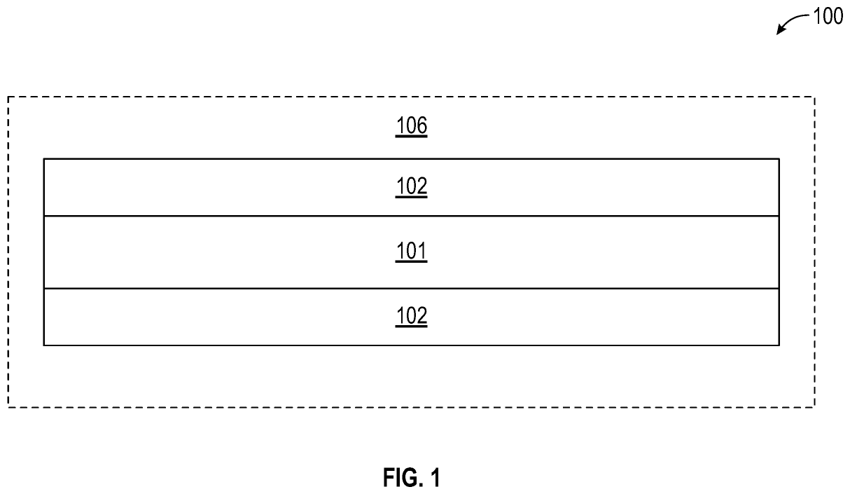

Without wishing to be bound by theory, it is believed that these excellent characteristics and performance attributes are due in particular to the combination of the following technical features as highlighted in FIG. 1: a) the use of a thermally-insulating porous foam layer (101) having specific properties; and b) and the use of a one or more thermally resistant layers (102) with particular properties disposed on the thermally-insulating porous foam layer. Optionally encapsulated by an encapsulant (106). The layers can be arranged in other configurations such as, for example, a porous foam layer (101) disposed on a thermally resistant layer (102). The assemblies can also further be stacked upon one another.

Still without wishing to be bound by theory, it is believed that the one or more thermally resistant layers as described above advantageously acts as a counterforce means for preventing or at least reducing unwanted compression forces endured by the thermally-insulating porous foam layer not only during the normal charging and discharging cycles of electric vehicle batteries, but also during more extreme conditions such as thermal runaway events. More specifically, it is believed that the one or more thermally resistant layers as described above can maintain a critical and minimum gap between the battery cells even under high-pressure conditions, whilst still ensuring the proper cushioning properties necessary for allowing the battery cells to expand and contract during their life cycle. This ability to maintain this set of properties is believed to directly and advantageously impact the excellent thermal insulation properties provided by the cushioning article of the disclosure.

The above-detailed set of advantageous properties provided by the multilayer construction described herein is even more surprising considering that the above-described one or more thermally resistant layers would have been expected to detrimentally affect the foam structure of the thermally-insulating porous foam layer thereby compromising the thermal barrier properties.

As such, the multilayer thermal barrier is suitable for use in various industrial applications, in particular for thermal management applications. The multilayer thermal barrier of the present disclosure is particularly suitable for thermal management applications in the transportation industry (in particular automotive industry), in particular as a thermal barrier, more in particular as a thermal runaway barrier. The multilayer thermal barrier as described herein is outstandingly suitable for use as a spacer having thermal runaway barrier properties in rechargeable electrical energy storage systems, in particular battery modules. Advantageously still, the multilayer thermal barrier of the disclosure may be used in the manufacturing of battery modules, in particular electric-vehicle battery modules and assemblies. In a beneficial aspect, the multilayer thermal barrier as described herein is suitable for manual or automated handling and application, in particular by fast robotic equipment, due in particular to its excellent robustness, dimensional stability and handling properties. In some advantageous aspects, the described multilayer thermal barrier is also able to meet challenging fire regulation norms due its outstanding flame resistance and heat stability characteristics.

In an advantageous aspect, the multilayer thermal barrier for use herein provides thermal insulation when subjected to a hot-side/cold side test (further defined in the example section). It takes greater than 500 seconds to reach a temperature of 150 C on the cold side.

In an advantageous aspect, the multilayer thermal barrier for use herein reaches a compression value of at least 60% when using a compression force of no greater than 1000 kPa, no greater than 900 kPa, no greater than 800 kPa, no greater than 700 kPa, no greater than 600 kPa, no greater than 500 kPa, no greater than 400 kPa, no greater than 300 kPa, no greater than 250 kPa, no greater than 200 kPa, no greater than 150 kPa, no greater than 100 kPa, no greater than 80 kPa, no greater than 60 kPa, or even no greater than 50 kPa, when measured according to the compression test method described in the experimental section.

In another advantageous aspect, the multilayer thermal barrier for use herein reaches a compression value of at least 20% when using a compression force of greater than 30 kPa, greater than 40 kPa, greater than 50 kPa, or even greater than 60 kPa, when measured according to the compression test method described in the experimental section.

In the context of the present disclosure, the term “adjacent” is meant to designate two superimposed films or layers which are arranged either directly next to each other, i.e. which are abutting or in direct contact with each other, or which are arranged not directly next to each other, i.e. when at least one additional film or layer is arranged between the initial two superimposed films or layers, for example an adhesive layer. In the context of the present disclosure, the term “immediately adjacent” is meant to designate two superimposed films or layers which are arranged directly next to each other, i.e. which are abutting or in direct contact with each other. The terms top and bottom layers or films, respectively, are used herein to denote the position of a layer or film relative to the surface of the substrate bearing such layer or film in the process of forming the polymeric foam layer. The direction into which one movable substrate, layer or film is moving is referred to herein as downstream direction. The relative terms upstream and downstream describe the position along the extension of the substrate.

### Thermally-Insulating Porous Foam Layers

Thermally-insulating porous foam layers for use herein are not particularly limited, but certain thermally-insulating porous foam layers may provide various advantages over other certain thermally-insulating porous foam layers.

According to an advantageous aspect, the porous foam layer for use herein comprises a material having a weight loss after three minutes at 600° C. of no greater than 70%, no greater than 60%, no greater than 50%, no greater than 40%, no greater than 30%, or even no greater than 25%, when measured according to the thermal stability test method described in the experimental section.

The types of porous foam layers as described above are typically referred to as thermally resistant materials or thermally resistant foam layers.

According to an exemplary aspect, the porous foam layer for use in the multilayer construction of the disclosure comprises a material selected from the group consisting of elastomeric materials, thermoplastic materials, thermoplastic elastomer materials, thermoplastic non-elastomeric materials, thermoset materials, and any combinations or mixtures thereof.

In one advantageous aspect, the porous foam layer for use herein comprises a material selected from the group consisting of silicone elastomers, fluorosilicone rubber, aromatic polyamides, polybenzimidazoles, polysulfides, polyimides, polysulfones, polyetherketones, flurorocarbons, polyisoprene, polybutadiene, polychloroprene, polyurethanes, polyolefins (in particular polyethylene, polypropylene and ethyl vinyl acetate), polystyrenes, and any combinations or mixtures thereof.

In a more advantageous aspect, the porous foam layer for use herein comprises a material selected from the group consisting of elastomeric materials.

In another more advantageous aspect, the polymeric foam layer for use herein reaches a compression value of at least 60% when using a compression force of no greater than 1000 kPa, no greater than 900 kPa, no greater than 800 kPa, no greater than 700 kPa, no greater than 600 kPa, no greater than 500 kPa, no greater than 400 kPa, no greater than 300 kPa, no greater than 250 kPa, no greater than 200 kPa, no greater than 150 kPa, no greater than 100 kPa, no greater than 80 kPa, no greater than 60 kPa, or even no greater than 50 kPa, when measured according to the compression test method described in the experimental section. This type of polymeric foam layers is typically referred to as (relatively highly) compressible polymeric foam layers (or soft polymeric foam layers).

In another more advantageous aspect, the porous foam layer for use herein comprises a material selected from the group consisting of silicone elastomers, in particular silicone rubbers, more in particular organopolysiloxane polymers.

In one particularly advantageous aspect of the disclosure, the porous foam layer for use herein is a silicone rubber foam layer.

According to an advantageous aspect, the silicone rubber foam layer for use herein is obtainable from a curable and foamable precursor of the silicone rubber foam layer, in particular an in-situ foamable precursor composition.

Precursor compositions of the silicone rubber foam for use herein are not particularly limited, as long as they are curable and foamable. Any curable and foamable precursors of a silicone rubber foam commonly known in the art may be formally used in the context of the present disclosure. Suitable curable and foamable precursors of a silicone rubber foam for use herein may be easily identified by those skilled in the art in the light of the present disclosure.

According to a more advantageous aspect, the precursor of the silicone rubber foam layer for use herein is a two-part composition.

In a typical aspect, the two-part precursor composition of the silicone rubber foam is selected from the group consisting of addition curing type two-part silicone compositions, condensation curing type two-part silicone compositions, and any combinations or mixtures thereof.

In a preferred aspect, the precursor of the silicone rubber foam for use herein comprises an addition curing type two-part silicone composition, in particular an addition curing type two-part organopolysiloxane composition.

Suitable addition curing type two-part organopolysiloxane compositions for use herein as the precursor of the silicone rubber foam may be easily identified by those skilled in the art based on the disclosure below.

According to a particularly advantageous aspect of the present disclosure, the precursor of the silicone rubber foam for use herein comprises:
a) at least one organopolysiloxane compound A;
b) at least one organohydrogenpolysiloxane compound B comprising at least two, in particular at least three hydrogen atoms per molecule;
c) at least one hydroxyl containing compound C;
d) an effective amount of a curing catalyst D, in particular a platinum-based curing catalyst; and
e) optionally, a foaming agent.

In an exemplary aspect, the at least one organopolysiloxane compound A for use herein has the following formula:

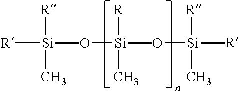

wherein:
R and R″, are independently selected from the group consisting of C₁ to C₃₀ hydrocarbon groups, and in particular R is an alkyl group chosen from the group consisting of methyl, ethyl, propyl, trifluoropropyl, and phenyl, and optionally R is a methyl group;
R′ is a C₁ to C₂₀ alkenyl group, and in particular R′ is chosen from the group consisting of vinyl, allyl, hexenyl, decenyl and tetradecenyl, and more in particular R′ is a vinyl group;
R″ is in particular an alkyl group such as a methyl, ethyl, propyl, trifluoropropyl, phenyl, and in particular R″ is a methyl group; and
n is an integer having a value in a range from 5 to 1000, and in particular from 5 to 100.

In another exemplary aspect, the at least one hydroxyl containing compound C for use herein is selected from the group consisting of alcohols, polyols in particular polyols having 3 to 12 carbon atoms and having an average of at least two hydroxyl groups per molecule, silanols, silanol containing organopolysiloxanes, silanol containing silanes, water, and any combinations or mixtures thereof.

In still another exemplary aspect, the at least one hydroxyl containing compound C for use herein is selected from the group consisting of silanol containing organopolysiloxanes.

According to an advantageous aspect of the present disclosure, the porous foam layer for use herein is obtainable by a process comprising the steps of:
a) providing a substrate;
b) providing a first solid film and applying it onto the substrate;
c) providing a coating tool provided with an upstream side and a downstream side, wherein the coating tool is offset from the substrate to form a gap normal to the surface of the substrate;
d) moving the first solid film relative to the coating tool in a downstream direction;
e) providing a curable (and foamable) precursor of the porous foam to the upstream side of the coating tool thereby coating the precursor of the porous foam through the gap as a layer onto the substrate provided with the first solid film;
f) providing a second solid film and applying it (at least partly) along the upstream side of the coating tool, such that the first solid film and the second solid film are applied simultaneously with the formation of the (adjacent) layer of the precursor of the silicone rubber foam;
g) foaming or allowing the precursor of the porous foam to foam;
h) curing or allowing the layer of the precursor of the porous foam to cure thereby forming the porous foam layer;
i) optionally, exposing the layer of the precursor of the porous foam to a thermal treatment; and

optionally, removing the first solid film and/or the second solid film from the porous foam layer.

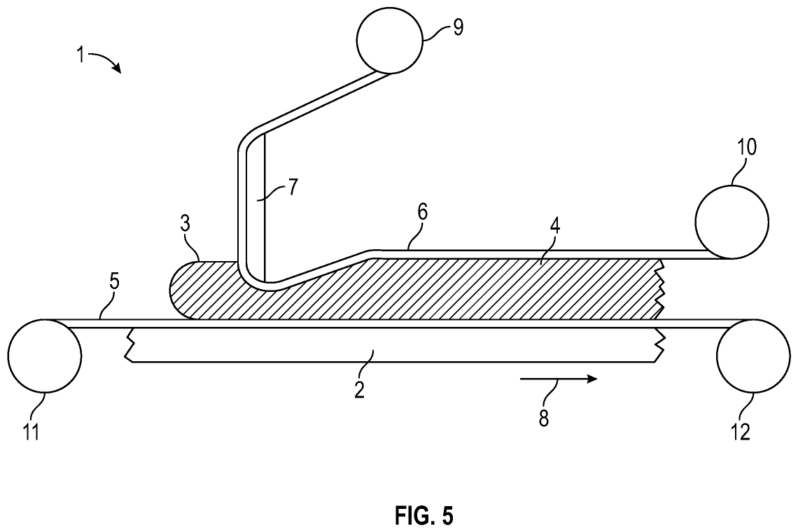

A schematic representation of an exemplary process of manufacturing a polymeric foam layer (in particular a silicone rubber foam layer) and a coating apparatus suitable for use in the manufacturing process is shown in FIG. 5. The coating apparatus 1 comprises a substrate 2, a coating tool 7 in the form of a coating knife, an unwinding roll 11 and a winding roll 12 for the first solid film 5, an unwinding roll 9 and a winding roll 10 for the second solid film 6. The downstream direction 8 in which (the substrate 2 provided with) the first solid film 5 is moved relative to the coating tool 7 is represented with an arrow accompanied with the corresponding reference numeral.

In a typical aspect of the disclosure, the curable and foamable precursor of the porous foam 3 is provided to the upstream side of the coating tool 7 thereby coating the precursor of the porous foam 3 through the gap as a layer onto the substrate 2 provided with the first solid film 5. In FIG. 5, the curable and foamable precursor of the porous foam 3 is represented as forming a so-called “rolling bead” at the upstream side of the coating tool 7. The second solid film 6 is applied (at least partly) along the upstream side of the coating tool 7, such that the first solid film 5 and the second solid film 6 are applied simultaneously with the formation of the layer of the precursor of the porous foam 3. The layer of the precursor of the porous foam 3 is thereafter allowed to foam and cure resulting into the porous foam layer 4, which is typically provided with the first solid film 5 on its bottom surface and with the second solid film 6 on its top surface. Optionally, the layer of the precursor of the porous foam 3 may be exposed to a thermal treatment, typically in an oven (not shown). In a typical aspect, the foaming of the layer of the precursor of the porous foam 3 results in a porous foam layer 4 having a thickness higher than the initial layer of the precursor of the porous foam 3. After processing, the first solid film 5 and/or the second solid film 6 may be removed from the porous foam layer 4.

According to an advantageous aspect, the precursor of the porous foam for use herein is an in-situ foamable composition, meaning that the foaming of the precursor occurs without requiring any additional compound, in particular external compound.

According to another advantageous aspect, the foaming of the precursor of the porous foam for use herein is performed with a gaseous compound, in particular hydrogen gas.

In a more advantageous aspect, the foaming of the precursor of the porous foam for use herein is performed by any of gas generation or gas injection.

According to a preferred aspect, the foaming of the precursor of the porous foam for use herein is performed by gas generation, in particular in-situ gas generation.

In an alternative aspect, the precursor of the porous foam for use herein further comprises an optional blowing agent.

Substrates for use herein are not particularly limited. Suitable substrates for use herein may be easily identified by those skilled in the art in the light of the present disclosure.

In a typical aspect of the disclosure, the substrate for use herein is a temporary support used for manufacturing purpose and from which the silicone rubber foam layer is separated and removed subsequent to foaming and curing. The substrate may optionally be provided with a surface treatment adapted to allow for a clean removal of the silicone rubber foam layer from the substrate (through the first solid film). Advantageously, the substrate for use herein and providing a temporary support may be provided in the form of an endless belt. Alternatively, the substrate for use herein may be a stationary (static) temporary support.

In one particular aspect of the disclosure, the porous foam layer obtained after foaming and curing is separated from the substrate and can be wound up, for example, into a roll.

According to one advantageous aspect of the disclosure, the substrate for use herein comprises a material selected from the group consisting of polymers, metals, ceramics, composites, and any combinations or mixtures thereof.

The porous foam layer for use in the disclosure may be obtainable by a process using a coating tool provided with an upstream side and a downstream side. The coating tool is offset from the substrate to form a gap normal to the surface of the substrate.

Coating tools for use herein are not particularly limited. Any coating tool commonly known in the art may be used in the context of the present disclosure. Suitable coating tools for use herein may be easily identified by those skilled in the art in the light of the present disclosure.

The coating tools useful in the present disclosure each have an upstream side (or surface) and a downstream side (or surface). In a typical aspect, the coating tool for use herein is further provided with a bottom portion facing the surface of the substrate receiving the precursor of the polymeric foam. The gap is measured as the minimum distance between the bottom portion of the coating tool and the exposed surface of the substrate. The gap can be essentially uniform in the transverse direction (i.e. in the direction normal to the downstream direction) or it may vary continuously or discontinuously in the transverse direction, respectively. The gap between the coating tool and the surface of the substrate is typically adjusted to regulate the thickness of the respective coating in conjunction with other parameters including, for example, the speed of the substrate in the downstream direction, the type of the coating tool, the angle with which the coating tool is oriented relative to the normal of the substrate, and the kind of the substrate.

In one advantageous aspect of the disclosure, the gap formed by the coating tool from the substrate (coating tool gap) is in a range from 10 to 3000 micrometers, from 50 to 2500 micrometers, from 50 to 2000 micrometers, from 50 to 1500 micrometers, from 100 to 1500 micrometers, from 100 to 1000 micrometers, from 200 to 1000 micrometers, from 200 to 800 micrometers, or even from 200 to 600 micrometers.

The coating tool for use herein can be arranged normal to the surface of the substrate, or it can be tilted whereby the angle between the substrate surface and the downstream side (or surface) of the coating tool is in arrange from 50° to 130°, or even from 80° to 100°. The coating tool useful in the present disclosure is typically solid and can be rigid or flexible. The coating tool for use herein may take various shapes, forms and sizes depending on the targeted application and expected characteristics of the silicone rubber foam layer.

In an advantageous aspect, the coating tool for use herein comprises a material selected from the group consisting of polymers, metals, ceramics, composites, glass, and any combinations or mixtures thereof. More advantageously, the coating tool for use herein comprises a material selected from the group consisting of metals, in particular aluminum, stainless steel, and any combinations thereof. Flexible coating tools for use herein are typically relatively thin and having in particular a thickness in the downstream direction in a range from 0.1 to 0.75 mm. Rigid coating tools for use herein are usually at least 1 mm, or even at least 3 mm thick.

According to a typical aspect of the disclosure, the coating tool for use herein is selected from the group consisting of coating knifes, coating blades, coating rolls, coating roll blades, and any combinations thereof.

In an advantageous aspect, the coating tool for use herein is selected from the group of coating knifes. It has been indeed found that the use of a coating tool in the form of a coating knife provides a more reproducible coating process and better-quality coating, which translates into a silicone rubber foam layer provided with advantageous properties.

In another advantageous aspect, the coating tool for use herein is selected from the group of coating rolls and air knives.

According to another advantageous aspect, the cross-sectional profile of the bottom portion of the coating tool (in particular, a coating knife) in the longitudinal direction is designed so that the precursor layer is formed, and the excess precursor is removed. Typically, the cross-sectional profile of the bottom portion which the coating tool exhibits at its transversely extending edge facing the substrate, is essentially planar, curved, concave or convex.

According to an advantageous aspect of the present disclosure, the porous foam layer of the disclosure is obtainable by a process wherein the step of providing a curable (and foamable) precursor of the porous foam to the upstream side of the coating tool is performed immediately prior to the step of providing a second solid film and applying it along the upstream side of the coating tool, such that the first solid film and the second solid film are applied simultaneously with the formation of the (adjacent) layer of the precursor of the porous foam.

According to another advantageous aspect of the present disclosure, the step of foaming or allowing the precursor of the porous foam to foam and the step of curing or allowing the layer of the precursor of the porous foam to cure thereby forming the porous foam layer are performed simultaneously.

The solid films for use herein as the first and the second solid films are not particularly limited. Any solid films commonly known in the art may be formally used in the context of the present disclosure. Suitable solid films for use herein may be easily identified by those skilled in the art in the light of the present disclosure.

According to one advantageous aspect, the first solid film and/or the second solid film for use in the present disclosure are impermeable films, in particular impermeable flexible films. As used herein, the term “impermeable” is meant to refer to impermeability to liquids and gaseous compounds, in particular to gaseous compounds.

According to another advantageous aspect of the disclosure, the first solid film and/or the second solid film for use herein are selected from the group consisting of polymeric films, metal films, composite films, and any combinations thereof.

In a more advantageous aspect of the disclosure, the first solid film and/or the second solid film for use herein are selected from the group consisting of polymeric films, in particular comprising a polymeric material selected from the group consisting of thermoplastic polymers.

In still a more advantageous aspect of the disclosure, the first solid film and/or the second solid film for use herein are polymeric films, wherein the polymeric material is selected from the group consisting of polyesters, polyethers, polyolefins, polyamides, polybenzimidazoles, polycarbonates, polyether sulfones, polyoxymethylenes, polyetherimides, polystyrenes, polyvinyl chloride, and any mixtures or combinations thereof.

In still a more advantageous aspect of the disclosure, the first solid film and/or the second solid film for use herein are polymeric films comprising a polymeric material selected from the group consisting of polyesters, polyolefins (in particular PP and PE), polyetherimides, and any mixtures or combinations thereof.

In a particularly advantageous aspect, the first solid film and/or the second solid film for use in the present disclosure are polymeric films comprising a polymeric material selected from the group consisting of polyesters, in particular polyethylene terephthalate.

According to an advantageous aspect of the present disclosure, the porous foam layer of the disclosure is obtainable by a process wherein the first solid film is applied to the bottom surface of the layer of the precursor of the porous foam, and the second solid film is applied to the top (exposed) surface of the layer of the precursor of the porous foam.

In a typical aspect of the disclosure, the first solid film and/or the second solid film are contacted directly to the adjacent porous foam layer.

In another advantageous aspect of the present disclosure, the first major (top) surface and the second (opposite) major (bottom) surface of the porous foam layer and/or the first solid film and/or the second solid film are free of any adhesion-promoting compositions or treatments, in particular free of priming compositions, adhesive compositions and physical surface treatments.

In an alternatively advantageous aspect of the present disclosure, the first major (top) surface and the second (opposite) major (bottom) surface of the porous foam layer and/or the first solid film and/or the second solid film comprises an adhesion-promoting compositions or treatments, in particular priming compositions, adhesive compositions and physical surface treatments.

In still another advantageous aspect of the disclosure, no intermediate layers of any sorts are comprised in-between the first major (top) surface or the second (opposite) major (bottom) surface of the porous foam layer and the first solid film and/or the second solid film.

In a typical aspect of the disclosure, the first and second solid films are smoothly contacted to the corresponding surfaces of the silicone rubber foam layer in a snug fit thereby avoiding (or at least reducing) the inclusion of air between the solid films and the corresponding surfaces of the porous foam layer.

According to one advantageous aspect, the porous foam layer for use herein comprises gaseous cavities, in particular gaseous hydrogen cavities, air gaseous cavities, and any mixtures thereof.

According to one advantageous aspect, the porous foam layer for use herein comprises gaseous cavities having an oblong shape in the direction of the layer thickness (i.e. in the direction perpendicular to the plane formed by the foam layer).

According to a more advantageous aspect, the gaseous cavities that may be present in the silicone rubber foam layer have an elongated oval shape in the direction of the layer thickness.

Advantageously still, the gaseous cavities for use herein are not surrounded by any ceramic or polymeric shell (other than the surrounding silicone polymer matrix).

In one particular aspect, the gaseous cavities for use herein have a mean average size (of its greatest dimension) no greater than 500 micrometers, no greater than 400 micrometers, no greater than 300 micrometers, no greater than 200 micrometers, no greater than 150 micrometers, no greater than 120 micrometers, no greater than 100 micrometers, no greater than 80 micrometers, no greater than 60 micrometers, no greater than 50 micrometers, no greater than 40 micrometers, no greater than 30 micrometers, or even greater than 20 micrometers (when calculated from SEM micrographs).

In another particular aspect, the gaseous cavities for use herein have a mean average size (of the greatest dimension) in a range from 5 to 3000 micrometers, from 5 to 2000 micrometers, from 10 to 1500 micrometers, from 20 to 1500 micrometers, from 20 to 1000 micrometers, from 20 to 800 micrometers, from 20 to 600 micrometers, from 20 to 500 micrometers, or even from 20 to 400 micrometers (when calculated from SEM micrographs).

According to a typical aspect, the porous foam layer for use herein is free of hollow cavities (surrounded by any ceramic or polymeric shell) selected from the group consisting of hollow microspheres, glass bubbles, expandable microspheres, in particular hydrocarbon filled expandable microspheres, hollow inorganic particles, expanded inorganic particles, and any combinations or mixtures thereof.

According to an advantageous aspect, the porous foam layer for use herein comprises a non-syntactic foam.

The porous foam layer for use herein may comprise additional (optional) ingredients or additives depending on the targeted application.

In a particular aspect of the disclosure, the porous foam layer for use herein further comprises an additive which is in particular selected from the group consisting of flame retardants, softeners, hardeners, filler materials, tackifiers, nucleating agents, colorants, pigments, conservatives, rheology modifiers (in particular aluminum hydroxide, magnesium hydroxide, magnesium carbonate, huntite, hydromagnesite, huntite-hydromagnesite, nesquehonite and calcium carbonate), UV-stabilizers, thixotropic agents, surface additives, flow additives, nanoparticles, antioxidants, reinforcing agents, toughening agents, silica particles, glass or synthetic fibers, thermally insulating particles, electrically conducting particles, electrically insulating particles, infrared opacifier particles, and any combinations or mixtures thereof.

In one beneficial aspect, the porous foam layer further comprises a non-flammable (or non-combusting) filler material. In a more beneficial aspect, the non-flammable filler material for use herein is selected from the group of inorganic fibers, in particular from the group consisting of mineral fibers, mineral wool, silicate fibers, ceramic fibers, glass fibers, carbon fibers, graphite fibers, asbestos fibers, aramide fibers, and any combinations or mixtures.

According to a more advantageous aspect, the non-flammable filler material for use herein is selected from the group consisting of mineral fibers, silicate fibers, ceramic fibers, asbestos fibers, aramide fibers, and any combinations or mixtures.

According to a particularly beneficial aspect, the non-flammable filler material for use herein is selected from the group consisting of mineral fibers. In the context of the present disclosure, it has indeed surprisingly been discovered that a polymeric foam (in particular silicone rubber foam) which further comprises mineral fibers are provided with excellent thermal resistance and thermal stability characteristics, as well as improved resistance to surface cracking and surface brittleness even after prolonged exposure to temperatures up to 600° C. Without wishing to be bound by theory, it is believed that these beneficial characteristics are due in particular to the excellent compatibility of the mineral fibers (in particular silicate fibers) with the surrounding polymeric matrix (in particular silicone polymer matrix), which participates in densifying and mechanically stabilizing the resulting matrix.

In a particular aspect of this execution, the non-flammable filler material for use herein is comprised in the polymeric foam in an amount ranging from 0.5 to 40 wt. %, from 1 to 30 wt. %, from 1 to 20 wt. %, from 1 to 10 wt. %, from 1 to 8 wt. %, from 2 to 8 wt. %, from 2 to 6 wt. %, or even from 3 to 6 wt. %, based on the overall weight of the precursor composition of the porous foam.

In another typical aspect, the porous foam layer for use herein is free of thermally conductive fillers.

According to one advantageous aspect of the disclosure, the porous foam layer for use herein has a density no greater than 500 kg/m³, no greater than 450 kg/m³, no greater than 400 kg/m³, no greater than 380 kg/m³, no greater than 350 kg/m³, no greater than 320 kg/m³, no greater than 300 kg/m³, no greater than 280 kg/m³, no greater than 250 kg/m³, no greater than 220 kg/m³, or even no greater than 200 kg/m³, when measured according to the method described in the experimental section.

According to another advantageous aspect of the disclosure, the porous foam layer for use herein has a density in a range from 200 to 500 kg/m³, from 200 to 450 kg/m³, from 200 to 400 kg/m³, from 200 to 380 kg/m³, from 200 to 350 kg/m³, from 200 to 320 kg/m³, from 200 to 300 kg/m³, from 200 to 280 kg/m³, or even from 200 to 250 kg/m³, when measured according to the method described in the experimental section.

According to still another advantageous aspect of the disclosure, the porous foam layer for use herein has a hardness (Shore 00) greater than 10, greater than 15, greater than 20, greater than 25, greater than 30, greater than 40, or even greater than 50.

According to still another advantageous aspect of the disclosure, the porous foam layer for use herein has a hardness (Shore 00) in a range from 10 to 80, from 10 to 70, from 20 to 70, from 25 to 60, from 25 to 55, from 30 to 55, from 30 to 50, from 30 to 45, or even from 30 to 40.

According to still another advantageous aspect of the disclosure, the porous foam layer for use herein has heat transfer time to 150° C. greater than 20 seconds, greater than 40 seconds, greater than 60 seconds, greater than 80 seconds, greater than 100 seconds, greater than 120 seconds, greater than 140 seconds, greater than 150 seconds, greater than 160 seconds, greater than 170 seconds, or even greater than 180 seconds, when measured according to the thermal insulation test method 1 described in the experimental section.

According to still another advantageous aspect of the disclosure, the porous foam layer for use herein has a heat transfer time to 150° C. in a range from 20 to 200 seconds, from 40 to 200 seconds, from 60 to 200 seconds, from 100 to 200 seconds, from 120 to 200 seconds, from 140 to 200 seconds, from 160 to 200 seconds, or even from 160 to 180 seconds, when measured according to the thermal insulation test method 1 described in the experimental section.

According to yet another advantageous aspect of the disclosure, the porous foam layer for use herein has a thermal conductivity no greater than 1 W/m/K, no greater than 0.8 W/m/K, no greater than 0.6 W/m/K, no greater than 0.5 W/m/K, no greater than 0.4 W/m/K, no greater than 0.3 W/m/K, no greater than 0.2 W/m/K, no greater than 0.1 W/m/K, no greater than 0.05 W/m/K, or even no greater than 0.01 W/m/K, when measured according to the test method described in the experimental section.

According to yet another advantageous aspect of the disclosure, the porous foam layer for use herein has a thermal conductivity in a range from 0.01 to 1 W/m/K, from 0.05 to 1 W/m/K, from 0.1 to 1 W/m/K, from 0.2 to 1 W/m/K, or even from 0.2 to 0.8 W/m/K, when measured according to the test method described in the experimental section.

According to yet another advantageous aspect of the disclosure, the porous foam layer for use herein undergoes a ceramization process at a temperature no greater than 600° C., no greater than 550° C., no greater than 500° C., no greater than 450° C., no greater than 400° C., no greater than 350° C., no greater than 300° C., or even no greater than 250° C.

According to yet another advantageous aspect of the disclosure, the porous foam layer for use herein undergoes a ceramization process at a temperature in a range from 200° C. to 600° C., from 200° C. to 550° C., from 200° C. to 500° C., from 200° C. to 450° C., from 200° C. to 400° C., from 200° C. to 350° C., from 250° C. to 350° C., or even from 250° C. to 300° C.

In the context of the present disclosure, it has indeed surprisingly been discovered that a porous foam layer which has the ability to undergo a ceramization process, in particular at a relatively low temperature, is provided with excellent thermal resistance and thermal stability characteristics.

According to still another advantageous aspect of the disclosure, the porous foam layer for use herein has a V-0 classification, when measured according to the UL-94 standard flammability test method.

In one advantageous aspect, the porous foam layer for use herein has a thickness no greater than 10000 micrometers, no greater than 8000 micrometers, no greater than 6000 micrometers, no greater than 5000 micrometers, no greater than 4000 micrometers, no greater than 3000 micrometers, no greater than 2500 micrometers, no greater than 2000 micrometers, or even no greater than 1500 micrometers.

In another advantageous aspect, the porous foam layer for use herein has a thickness in a range from 100 to 10000 micrometers, from 100 to 8000 micrometers, from 100 to 6000 micrometers, from 200 to 5000 micrometers, from 300 to 5000 micrometers, from 300 to 4500 micrometers, from 300 to 4000 micrometers, from 500 to 4000 micrometers, from 500 to 3000 micrometers, from 500 to 2500 micrometers, from 500 to 2000 micrometers, from 500 to 1500 micrometers, from 800 to 1500 micrometers. or even from 1000 to 1500 micrometers.

According to one particular aspect of the disclosure, the porous foam layer for use herein may be provided with the first solid film and/or the second solid film. In an alternative execution, the polymeric foam layer may not be provided with any of the first solid film and/or the second solid film.

As will be apparent to those skilled in the art, the porous foam layer for use herein may take various forms, shapes and sizes depending on the targeted application. Similarly, the porous foam layer for use herein may be post-processed or converted as it is customary practice in the technical field.

According to one exemplary aspect, the porous foam layer for use herein may take the form of a roll which is wound, in particular level-wound, around a core. The porous foam layer in the wound roll may or may not be provided with the first solid film and/or the second solid film.

According to one exemplary aspect, the porous foam layer for use herein may be cut into smaller pieces of various forms, shapes and sizes.

### Thermally Resistant Layer

The multilayer thermal barrier of the present disclosure further comprises one or more thermally resistant layers disposed on or adjacent to the thermally-insulating porous foam layer.

The one or more thermally resistant layers are a single-layer of a dry-laid or wet-laid nonwoven fibrous thermal insulation (e.g., in the form of a mat, sheet, strip, or three-dimensional thin-walled structure) comprising a fiber matrix of ceramic or otherwise nonmetallic (i.e., not a metal, metal alloy, or metal composite) inorganic fibers, thermally insulative ceramic or otherwise nonmetallic (i.e., not a metal, metal alloy, or metal composite) inorganic particles dispersed evenly, uniformly, generally or otherwise throughout or to the extent permitted by the manufacturing process (e.g., there can be a little sedimentation of the particles on the bottom of the mat in both the dry laid and wet laid processes) within the fiber matrix, and an organic or inorganic binder (e.g., organic or inorganic adhesive binder, organic or inorganic binder fibers that are needle punched, stitched or otherwise mechanically entangled into the fiber matrix so as to hold together the fiber matrix, etc.) dispersed evenly, uniformly, generally or otherwise throughout or to the extent permitted by the manufacturing process within the fiber matrix so as to bond together the inorganic filler particles and inorganic fibers or otherwise hold together the fiber matrix for as long as needed to at least survive the degree of handling required (e.g., during the encapsulation process) before being installed between battery cells.

The one or more thermally resistant layers can be optionally encapsulated by an organic (e.g., polymeric, paper, etc.) encapsulation layer (e.g., one layer or multiple opposing sandwiching layers, with each layer being in the form of a film, coating, organic fibrous nonwoven or woven fabric, etc.) encapsulating all of, a majority of or a portion of at least one or both major faces and preferably also all of, a majority of or a portion of the peripheral edge of the single-layer of nonwoven fibrous thermal insulation so as to prevent or significantly reduce the shedding or loss of inorganic fibers or particles from the encapsulated single-layer of nonwoven fibrous thermal insulation.

The reduction of inorganic fiber or particle shedding is significant, when the number of inorganic fibers or particles lost is less than 10%, 5% or 1% by weight percent of the original fiber or particle content of the layer of nonwoven fibrous thermal insulation. The thinner the organic encapsulation layer (i.e., the lower the organic content of the barrier) the better the hot/cold test results.

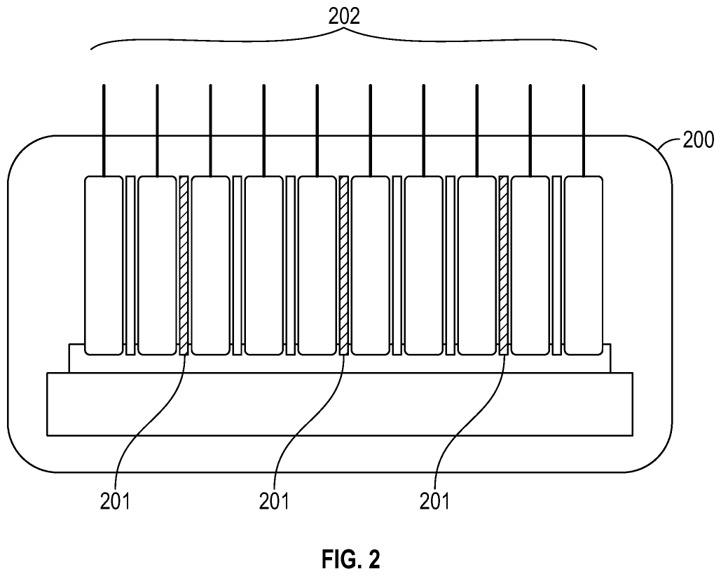

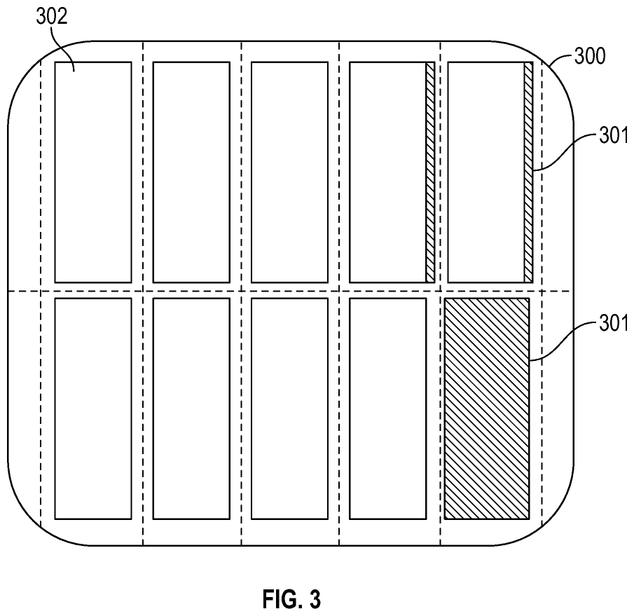

The present multilayer thermal barrier may be used between battery modules or assemblies, or it may be positioned on the top of the battery module or around the perimeter. FIG. 2. and FIG. 3 show a battery module (200, 300) containing battery cells (202, 302). The multilayer thermal barrier (201, 301) is shown to be positioned between adjacent battery cells (202, 302) and on top of the battery cells (202, 302) respectively. The multilayer thermal barriers may be provided (a) in a container (e.g., a cardboard or other box) in the form of a stack, (b) adhered in series on a major surface of a length of double sided adhesive tape, with an opposite major surface of the tape being protected by a release liner, or (c) sandwiched or otherwise disposed so as to be encapsulated in a series of spaced apart nonwoven fibrous thermal insulations between two opposing lengths of organic (e.g., polymeric) encapsulation layers (e.g., in the form of two films, coatings, fibrous fabrics, etc.).

Inorganic binders, organic binders, or a combination of both for the thermally resistant layers may include, e.g., those disclosed in U.S. Pat. No. 8,834,759. An example of an inorganic binder useful in both dry-laid or wet-laid fiber processing can include particles of silicone that convert to fusible silica when heated. An organic-inorganic hybrid binder may also be useful such as, e.g., WACKER® MQ 803 TF, which is a co-hydrolysis product of tetra-alkoxy silane (Q unit) and trimethyl-alkoxy silane (M unit). The chemical structure of WACKER® MQ 803 TF can be seen as a three dimensional network of polysilicic acid units which are end-blocked with trimethylsilyl groups. Some residual ethoxy and hydroxy functions are present. The average molecular weight can be exactly controlled by the ratio of M and Q units. This ratio approx. is 0.67 for WACKER® MQ 803 TF.

Exemplary binder fibers include the use of bicomponent core-sheath polymeric fibers in a dry-laid process. In a wet-laid process, ethylene vinyl acetate latex dispersion binder, bicomponent core-sheath polymeric fibers, or a combination of both can be used. When a polymeric binder fiber is used, the binder can be activated by heating and compressing the nonwoven fibrous thermal insulation material. A combination of organic and inorganic binders can also be used.

Exemplary commercially available thermally resistant layers that can be used in the multilayer thermal barrier assembly include Flame Barrier FRB-NT Series, FRB-BK Series, FRB-WT Series, and FRB-NC Series (all available from 3M Company), flexible or rigid mica paper or sheets such as NEMA 86P available from Asheville Mica, NewsPort News, VA, United States or flexible mica sheets from USA Mica, Tekonsha, MI. United States.

As used herein, the term “inorganic” refers to ceramic or otherwise nonmetallic (i.e., not a metal, metal alloy, or metal composite) inorganic material.

A “thermal runaway” is when a battery cell experiences an exothermic chain reaction causing the phenomenon of an uncontrollable temperature rise of the battery cell. The exothermic chain reaction may be caused, for example, by over-heating of the battery cell, over-voltage of the battery cell, and mechanical puncture of the battery cell, among other reasons.

A “thermal propagation” is when a battery cell thermal runaway causes the remaining battery cells in a battery pack or system to undergo the thermal runaway phenomenon.

A “thermal runaway event” refers to the overheating of one battery cell, in a container of battery cells, causing a chain reaction of adjacent battery cells overheating, and potentially exploding or catching fire, until the number of overheated battery cells reaches a critical point of propagation resulting in all or more than half of the battery cells in the module or assembly of modules being destroyed. Factors that can cause a battery cell to overheat include: physical damage, applying over voltage, overheating (internal battery cell shorting).

As the energy density of a battery cell increases, the temperature at which the battery cell starts to malfunction (e.g., from at least losing its efficiency or failing to function up to igniting, burning or exploding) decreases. Likewise, as the energy density of the battery cell decreases, the temperature at which the battery cell starts to malfunction increases. For example, with a controlled ramping up of the temperature, NMC811 type battery cells tend to start malfunctioning or even blow up when the temperature reaches around 120° C. to 130° C., while NMC622 type battery cells start to malfunction or even blow up when they reach a temperature of around 180° C. The corresponding temperature is higher for battery cells with lower energy densities (e.g., NMC532 and NMC433 type battery cells). With physically larger battery cells or when the temperature is rapidly increased, thermal diffusion through the battery cell can result in the localized temperature taking longer to get up to the critical point. It is believed that this thermal diffusion effect can cause the actual temperature at which the battery cell starts to malfunction or blow up to be somewhat higher. It can be desirable for the thermal runaway barrier of the present invention to prevent an adjacent battery from reaching a temperature in the range of from about 130° C. up to about 150° C.

As used herein, “preventing” a thermal runaway event refers to preventing the overheating of a single battery cell from causing the overheating of battery cells that are adjacent to the single battery cell. The barrier is considered to prevent a thermal runaway event, when adjacent battery cells do not reach above 130 to 150° C.

As used herein, “stopping” a thermal runaway event refers to the overheating of a single battery cell only causing adjacent battery cells (i.e., one or two battery cells away on either side of the overheating battery cell) to overheat and the remaining battery cells in the battery module or assembly do not overheat.

As used herein, “slowing down” a thermal runaway event refers to the thermal runaway event being slowed down at least long enough to allow personnel adjacent to the battery module or assembly (e.g., an occupant inside of an electric vehicle passenger compartment) to escape to a safe distance away from the battery module or assembly, before being injured by the thermal runaway event. Once a battery cell malfunctions (e.g., is on fire) and thermal barrier is in place, the time for any adjacent battery cells to propagate the malfunction (e.g., fire) is at least more than five minutes, and preferably more than ten minutes or even twenty minutes.

The inorganic particles can be solid, hollow or contain multiple voids. Such particles can include, e.g., particles of unexpanded intumescent material, irreversibly or permanently expanded intumescent material, diatomaceous earth, inorganic aerogel material, porous ceramic (e.g., silica) material, irreversibly or permanently expanded perlite mineral, hollow ceramic or otherwise inorganic (e.g., glass) microspheres, etc. Such inorganic particles that contain voids such as, e.g., those found in irreversibly or permanently expanded vermiculite are particularly desirable. Particles of irreversibly or permanently expanded perlite mineral also contain voids, but perlite mineral is harder and less compressible than vermiculite mineral. Silica-based and other aerogel particles also contain voids.

As used herein, an irreversibly or permanently expanded intumescent particle (e.g., particle of vermiculite and perlite mineral) refers to a particle that has been heated to a temperature and for a time that causes the particle to irreversibly or permanently expand to at least 10% and up to 100% of its expandability, either by being pre-expanded before being used to form the thermal runaway barrier, or post-expanded after it is incorporated into the single layer of nonwoven fibrous thermal insulation.

Intumescent particles (e.g., vermiculite particles) can be permanently expanded by overheating the particles to beyond the point of reversibility (e.g., in the range of from about 350° C. up to about 1000° C. for vermiculite). Such a permanently expanded intumescent particle (e.g., vermiculite particle) can have an expanded accordion or worm-like structure that is easier to break apart into smaller particles, compared to the same particle in its unexpanded state, because of its elongated geometry, lower density and lower mechanical stability. As the heating temperature increases, the degree of permanent expansion of the particle increases (i.e., the particles can get larger and/or longer). It may also be desirable to use vermiculite that has been permanently expanded by a chemical treatment method.

Because they are easier to break apart in their expanded state, it can be desirable to post-expand the intumescent particles, after the unexpanded intumescent particles have been incorporated into the nonwoven fibrous thermal insulation. Even if gentle processing is employed so as not to substantially break them apart, it is believed that incorporating pre-expanded intumescent particles into the nonwoven fibrous thermal insulation can still result in the expanded particles becoming oriented into the plane (i.e., x-axis, y-axis, and/or therebetween) of the insulation. For example, with pre-expanded vermiculite particles, the elongated particles can become generally aligned with the fibers in the longitudinal or downstream direction (i.e., y-axis), rather than in the thickness direction (i.e., z-axis), of the nonwoven fibrous thermal insulation.

In contrast, when they are post-expanded (i.e., after the nonwoven fibrous thermal insulation is made with unexpanded intumescent particles), the expanded intumescent particles are not oriented primarily in the plane of the insulation. Unexpanded intumescent particles typically have a more uniform structural geometry (i.e., have an aspect ratio closer to 1) compared to the same particles in its expanded state. It is believed that this more uniform structural geometry is less likely to be influenced by the alignment of the fibers during the formation of the nonwoven fibrous thermal insulation. As a result, the post-expanded intumescent particles are more likely to be oriented isotropically within the nonwoven fibrous thermal insulation. For example, with post-expanded vermiculite particles, the elongated particles can become aligned in the thickness direction (i.e., z-axis), in plane (i.e., x-axis, y-axis, and/or therebetween), or off-axis thereof. It is believed this difference between the orientation of pre-expanded particles versus post-expanded particles is caused by the unexpanded particles having a more uniform structural geometry than that exhibited while in their expanded state.

The thermally resistant layers contain an amount of inorganic fibers in the range of from as low as about 15 to 19% up to as high as about 70, 75, 80, 85 or 90%, by weight of the layer of nonwoven fibrous thermal insulation.

The thermally resistant layers may contain an amount of fiber shot in the range of from about 3% up to about 60% by weight of the amount of inorganic fibers in the layer of nonwoven fibrous thermal insulation.

If no insulative particles are added, then inorganic fiber content is 95.2% in dry-laid and 95.5% in wet-laid. At the lowest level of aerogel filler loading, the inorganic fiber content is 72% for dry-laid and wet-laid. For dry laid nonwoven fibrous thermal insulation, the fibers are opened (i.e., the bulk fibers are separated, made less dense), which may remove some shot. For wet laid nonwoven fibrous thermal insulation, the fibers are wet cleaned, which removes more shot than is removed by the dry laid opening process. There is about 40% shot in uncleaned SuperWool Plus from Morgan, actual fibrous material content is 19-43% in the nonwoven fibrous thermal insulation. It can be desirable for the nonwoven fibrous thermal insulation to have a fiber content in the range of from about 10% up to about 80%. The lower amount of fiber would require a higher amount of organic binder. Other additives (e.g., flame retardant materials, endothermic materials, infra-red reflective materials, etc.) may be included.

The thermally resistant layers can contain an amount of inorganic thermally insulative particles in the range of from as low as about 10% up to as high as about 40%, 45%, 50%, 55% or 60%, by weight of the layer of nonwoven fibrous thermal insulation. For example, a particle content as high as 60% can be achieved using a dry-laid process, and as high as 50% using a wet laid process.

The thermally resistant layers can contain an amount of organic binder in the range of from as low as about 2.5%, 3.0%, or 3.5% up to as high as about 7.5%, 8.0%, 8.5%, 9.0%, 9.5%, or 10.0%, by weight of the layer of nonwoven fibrous thermal insulation.

The thermally resistant layers according to any one of embodiments can have an installed (i.e., compressed, e.g., in between 2 battery cells) thickness in the range of from about 0.5 mm up to about 10 mm, where the lower limit can be about 0.5 mm, 0.6 mm, 0.7 mm, 0.8 mm, 0.9 mm, 1.0 mm, 1.1 mm, 1.2 mm, 1.3 mm, 1.4 mm, 1.5 mm, and the upper limit can be about 1.5 mm, 1.6 mm, 1.7 mm, 1.8 mm, 1.9 mm, 2.0 mm, 2.1 mm, 2.2 mm, 2.3 mm, 2.4 mm or 2.5 mm. In some applications, the installed thickness may even be as high as about 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, 5.0 mm, 6 mm, 7 mm, 8 mm, 9 mm, or even 10 mm. The installed thickness of the layer of nonwoven fibrous thermal insulation is always less than its uninstalled (i.e., uncompressed) thickness. The performance of the thermally resistant layer is measured when it is in its installed (i.e., compressed) condition.

The thermally resistant layers according to any one of embodiments can have an uninstalled (i.e., uncompressed) thickness in the range of from about 1 mm up to less than 20 mm, where the lower limit can be about 1 mm, 1.5 mm, 2 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, and the upper limit can be about 4.0 mm, 4.1 mm, 4.2 mm, 4.3 mm, 4.4 mm, 4.5 mm, 4.6 mm, 4.7 mm, 4.8 mm, 4.9 mm, 5.0 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm. The uncompressed thickness of the layer of nonwoven fibrous thermal insulation is always greater than its installed thickness.

The thermally resistant layers according to any one of embodiments can have a basis weight in the range of from as low as about 250 g/m2, 300 g/m2, 350 g/m2 or 400 g/m2, for about a 1 mm gap, and up to as high as about 800 g/m2, 850 g/m2, 900 g/m2, 950 g/m2 or 1000 g/m2, for about a 2 mm, 2.5 mm, 3.0 mm, 3.5 mm, 4.0 mm, 4.5 mm, or less than a 5.0 mm gap. In one embodiment, the inorganic thermally insulative particles are vermiculite, and the layer of nonwoven fibrous thermal insulation has a basis weight of 300 g/m2 and is installed in about a 1 mm gap. In another embodiment, the inorganic thermally insulative particles are silica aerogel, and the layer of nonwoven fibrous thermal insulation has a basis weight of 250 g/m2 and is installed in about a 1 mm gap.

The thermally resistant layers according to any one of embodiments can have a basis weight in the range of from about 250 g/m2 up to about 400 g/m2. In particular, for example, a basis weight in the range of from about 300 g/m2 up to 400 g/m2 can be desirable, when the inorganic thermally insulative particles are vermiculite and the gap is about 1 mm. A basis weight of about 250 g/m2 can also be desirable, when aerogel particles are used and the gap is about 1 mm. When the gap is about 2.0 mm, a basis weight in the range of from about 800 g/m2 up to about 1000 g/m2 may be desirable.

The thermally resistant layers according to any one of embodiments are made from or at least comprise particles of one or any combination of the materials selected from the group consisting of inorganic (e.g., titania, zirconia, and/or silica) aerogel, xerogel, hollow or porous ceramic (e.g., glass, alumina, etc.) microspheres (e.g., bubbles, foamed spheres, beads, etc.), unexpanded vermiculite, irreversibly or permanently expanded vermiculite (i.e., vermiculite that has been heated to a temperature and for a time that causes the vermiculite particles to irreversibly or permanently expand to at least 10% and up to 100% of its expandability, either by being pre-expanded before being used to form the barrier, or post-expanded after it is in the single layer of nonwoven fibrous thermal insulation), fumed silica and otherwise porous silica, irreversibly or permanently expanded perlite (i.e., perlite that has been heated to a temperature and for a time that causes the perlite particles to irreversibly or permanently expand to at least 10% and up to 100% of its expandability, either by being pre-expanded before being used to form the barrier, or post-expanded after it is in the single layer of nonwoven fibrous thermal insulation), unexpanded perlite, pumicite, expanded clay, diatomaceous earth, titania, and zirconia.

The thermally resistant layers according to any one of embodiments can contain inorganic fibers of the fiber matrix that are selected from the group of fibers consisting of alkaline earth silicate fibers, refractory ceramic fibers (RCF), polycrystalline wool (PCW) fibers, basalt fibers, glass fibers and silicate fiber. Glass fibers and silica fibers typically do not contain any or only nominal shot particles. PCW typically contains a max of 5% shot particles, while alkaline earth silicate (AES) fibers contain up to 60% shot particles when uncleaned and as low as about 10-30% minimum shot particles when cleaned).

The thermally resistant layers according to any one of embodiments can contain organic binders are in the form of polymer fibers (e.g., PE/PET, PET, FRPET), dry polymer powder (e.g., LDPE, polyamide, epoxy resin powder (3M SCOTCHCAST 265, 3M SCOTCHKOTE 6258)) or a liquid binder (e.g., acylic latex, ethylene vinyl acetate (EAF68) latex, silicone, polyurethane etc.).

The thermally resistant layers according to any one of embodiments can be encapsulated by the organic encapsulation layer. The organic encapsulation layer is in the form of a continuous layer, a discontinuous layer (e.g., having perforations, through-holes, or porosity that would allow a gas to penetrate through the organic layer), or a combination of both. In addition, the organic layer can be in the form of a film, scrim, woven or nonwoven fabric, adhesive (e.g., a thermoplastic or hot-melt adhesive) layer or a combination thereof. One example of the organic layer is a co-polyester polymeric film.

The organic encapsulation layer can be a calendared layer, hot-melt coated layer, spray coated layer, dip coated layer, or laminated layer (e.g., with by use of a pressure sensitive adhesive or other adhesive) and can be sealed around the peripheral edge.

The thermally resistant layers according to any one of embodiments pass a UL94 VO test.

The thermally resistant layers according to any one of embodiments include inorganic thermally insulative particles that are made from or at least comprise particles of irreversibly or permanently expanded intumescent material. The expanded intumescent material can be irreversibly or permanently expanded in the range of from at least about 10%, 20%, 30%, 40%, 50%, 60%, 70%, 80% or 90% up to 100% of its expandability.

The inorganic thermally insulative particles in the thermally resistant layers may comprise particles of fumed silica having a surface area in the range of from about 100 m2/g up to about 400 m2/g.

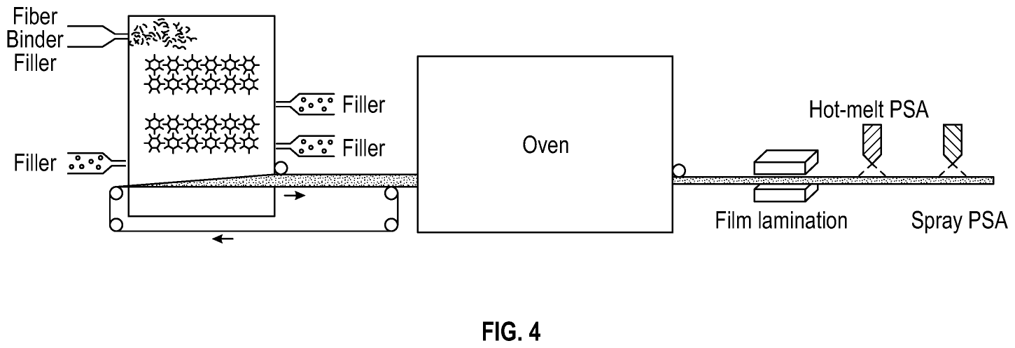

The thermally resistant layers according to any one of embodiments may be assembled by forming the layer of nonwoven fibrous thermal insulation using a wet-laid process or dry-laid process. Refer to FIG. 4. Inorganic thermally insulative particles are disposed so as to be evenly or uniformly distributed throughout or within the layer of nonwoven fibrous thermal insulation. The layer may be exposed to heat for a time to cause unexpanded particles to irreversibly expand. The heating may occur before or after the inorganic thermally insulative particles are disposed within the layer of nonwoven fibrous thermal insulation. Heating may also occur after the inorganic thermally insulative particles are disposed within the layer of nonwoven fibrous thermal insulation.

In one particular aspect of the disclosure, the at least one expanding and/or contracting surface expands (and/or contracts) upon exposure to thermal energy (heat).

According to one advantageous aspect, the cushioning article of the disclosure has a heat transfer time to 150° C. greater than 20 seconds, greater than 60 seconds, greater than 100 seconds, greater than 150 seconds, greater than 180 seconds, greater than 200 seconds, greater than 240 seconds, greater than 280 seconds, greater than 300 seconds, greater than 320 seconds, greater than 340 seconds, greater than 350 seconds, or even greater than 360 seconds, when measured at 0.1 MPa according to the thermal insulation test method 2 described in the experimental section.

According to another advantageous aspect of the disclosure, the multilayer thermal barrier has a heat transfer time to 150° C. in a range from 20 to 380 seconds, from 40 to 380 seconds, from 60 to 380 seconds, from 100 to 380 seconds, from 150 to 380 seconds, from 180 to 380 seconds, from 200 to 380 seconds, from 250 to 380 seconds, or even from 300 to 380 seconds, when measured at 0.1 MPa according to the test method 2 described in the experimental section.

According to still another advantageous aspect of the disclosure, the multilayer thermal barrier has a heat transfer time to 150° C. greater than 20 seconds, greater than 40 seconds, greater than 60 seconds, greater than 80 seconds, greater than 100 seconds, greater than 120 seconds, greater than 140 seconds, or even greater than 150 seconds, when measured at 1 MPa according to the thermal insulation test method 2 described in the experimental section.

According to yet another advantageous aspect, the multilayer thermal barrier of the disclosure has a heat transfer time to 150° C. in a range from 20 to 180 seconds, from 40 to 180 seconds, from 60 to 180 seconds, from 100 to 180 seconds, from 120 to 180 seconds, from 140 to 180 seconds, or even from 140 to 160 seconds, when measured at 1 MPa according to the thermal insulation test method 2 described in the experimental section.

According to yet another advantageous aspect, the multilayer thermal barrier of the disclosure has a thermal conductivity no greater than 1 W/m/K, no greater than 0.8 W/m/K, no greater than 0.6 W/m/K, no greater than 0.5 W/m/K, no greater than 0.4 W/m/K, no greater than 0.3 W/m/K, no greater than 0.2 W/m/K, no greater than 0.1 W/m/K, no greater than 0.05 W/m/K, or even no greater than 0.01 W/m/K, when measured according to the test method described in the experimental section.

In yet another advantageous aspect, the multilayer thermal barrier of the disclosure has a thermal conductivity in a range from 0.01 to 1 W/m/K, from 0.05 to 1 W/m/K, from 0.1 to 1 W/m/K, from 0.2 to 1 W/m/K, or even from 0.2 to 0.8 W/m/K, when measured according to the test method described in the experimental section.

In yet another advantageous aspect, the multilayer thermal barrier of the disclosure has a V-0 classification, when measured according to the UL-94 standard flammability test method.

According to an exemplary aspect of the disclosure, the multilayer thermal barrier has a thickness in a range from 100 to 20000 micrometers, from 100 to 15000 micrometers, from 100 to 10000 micrometers, from 100 to 8000 micrometers, from 100 to 6000 micrometers, from 200 to 5000 micrometers, from 300 to 5000 micrometers, from 300 to 4500 micrometers, from 300 to 4000 micrometers, from 500 to 4000 micrometers, from 1000 to 3000 micrometers, from 1000 to 2500 micrometers, from 1500 to 2500 micrometers, or even from 2000 to 2500 micrometers.

According to another aspect, the present disclosure is directed to a process for manufacturing a multilayer thermal barrier as described above, wherein the process comprises the steps of:
a) providing a porous foam layer as described above;
b) providing one or more thermally resistant layers as described above; and
c) layering the thermally resistant layers on one or more of the surfaces of the porous foam layer or layering the porous foam layer on one or more of the surfaces of the thermally resistant layer.

According to still another aspect, the present disclosure relates to a rechargeable electrical energy storage system, in particular a battery module, comprising a multilayer thermal barrier article as described above.

In yet another aspect, the present disclosure is directed to a battery module comprising a plurality of battery cells separated from each other by a gap, and a multilayer thermal barrier as described above positioned in the gap between the battery cells.

Suitable battery modules, battery subunits and methods of manufacturing thereof for use herein are described e.g. in EP-A1-3352290 (Goeb et al.), in particular in FIG. 1 to FIG. 3 and in paragraphs [0016] to [0035], the content of which is herewith fully incorporated by reference.

According to an advantageous aspect of the battery module according to the disclosure, the battery cells for use herein are selected from the group consisting of pouch energy storage cells and prismatic energy storage cells, in particular from the group of pouch energy storage cells.

According to another aspect, the present disclosure is directed to a method of manufacturing a battery module, which comprises the steps of:
a) providing a plurality of battery cells separated from each other by a gap; and
b) positioning a multilayer thermal barrier as described above in the gap between the battery cells.

According to still another aspect, the present disclosure is directed to a method of cushioning at least one expanding (and/or contracting) surface, which comprises the step of applying a cushioning article as described above onto at least part of the least one expanding (and/or contracting) surface. In one particular aspect, the at least one expanding (and/or contracting) surface expands (and/or contracts) upon exposure to thermal energy (heat).

According to still another aspect, the present disclosure relates to the use of a cushioning article as described above for industrial applications, in particular for thermal management applications, more in particular in the transportation industry, even more in particular in the automotive, aeronautic and aerospace industries.

According to yet another aspect, the present disclosure relates to the use of a cushioning article as described above as a thermal barrier, in particular a thermal runaway barrier.

In yet another aspect, the present disclosure relates to the use of a cushioning article as described above as a thermal barrier spacer, in particular a thermal runaway barrier spacer, in a rechargeable electrical energy storage system, in particular a battery module.

In yet another aspect, the present disclosure relates to the use of a cushioning article as described above as a thermal barrier spacer, in particular a thermal runaway barrier spacer, between the plurality of battery cells present in a rechargeable electrical energy storage system, in particular a battery module.

In yet another aspect, the present disclosure relates to the use of a cushioning article as described above as a cushioning spacer, in particular between the plurality of battery cells present in a rechargeable electrical energy storage system, in particular a battery module.

In yet another aspect, the present disclosure relates to the use of a cushioning article as described above as a cushioning spacer for cushioning at least one expanding (and/or contracting) surface, wherein the at least one expanding surface expands (and/or contracts) in particular upon exposure to thermal energy (heat).

### EXEMPLARY EMBODIMENTS

1. A multilayer thermal barrier, comprising
   one or more thermally-insulating porous foam layers,
   one or more thermally resistant layers disposed on the thermally-insulating porous foam layer,
wherein a thermally-insulating porous foam layer alternates with a thermally resistant layer,
wherein the thermally resistant layers comprise insulative particles,
wherein the multilayer thermal barrier exhibits a pressure of at least 30 kPa when subjected to a compression of 20%,
wherein the multilayer thermal barrier exhibits a pressure of less than 2,500 kPa when subjected to a compression of 55%, and
wherein a cold plate takes more than 500 seconds to reach 150° C. in a HCST test.
2. A multilayer thermal barrier, comprising
   one or more thermally-insulating porous foam layers,
   one or more thermally resistant layers disposed on the thermally-insulating porous foam layer,
wherein a thermally-insulating porous foam layer alternates with a thermally resistant layer,
wherein the thermally resistant layers comprise insulative particles,
wherein the multilayer thermal barrier exhibits a pressure of at least 30 kPa when subjected to a compression of 20%,
wherein the multilayer thermal barrier exhibits a pressure of less than 2,500 kPa when subjected to a compression of 55%,
wherein a cold plate takes at least 500 seconds to reach 150° C. in a HCST test, and
wherein the weight ratio of thermally-insulating porous foam layers to thermally resistant layers is from 20%-75% in the multilayer thermal barrier.
3. A multilayer thermal barrier, comprising
   one or more thermally-insulating porous foam layers,
   one or more thermally resistant layers disposed on the thermally-insulating porous foam layer,
wherein a thermally-insulating porous foam layer alternates with a thermally resistant layer,
wherein the thermally resistant layers comprise insulative particles,
wherein a cold plate takes at least 500 seconds to reach 150° C. in a HCST test, and
wherein the weight ratio of thermally-insulating porous foam layers to thermally resistant layers is from 20%-75% in the multilayer thermal barrier.
4. A multilayer thermal barrier, comprising
   one or more thermally-insulating porous foam layers,
   one or more thermally resistant layers disposed on the thermally-insulating porous foam layer,
wherein a thermally-insulating porous foam layer alternates with a thermally resistant layer,
wherein the thermally resistant layers comprise insulative particles,
wherein the multilayer thermal barrier exhibits a pressure of at least 30 kPa when subjected to a compression of 20%,
wherein the multilayer thermal barrier exhibits a pressure of less than 2,500 kPa when subjected to a compression of 55%, and
wherein a cold plate takes at least 500 seconds to reach 150° C. in a HCST test.,
wherein the multilayer thermal barrier does not have the following 3-layer construction:
   a first thermally resistant layer,
   a thermally-insulating porous foam layer immediately adjacent to the first thermally resistant layer, and
   a second thermally resistant layer immediately adjacent to the thermally-insulating porous foam layer.
5. A multilayer thermal barrier, comprising
   one or more thermally-insulating porous foam layers,
   one or more thermally resistant layers disposed on the thermally-insulating porous foam layer,
wherein the thermally resistant layers comprise insulative particles,
wherein the multilayer thermal barrier exhibits a pressure of at least 30 kPa when subjected to a compression of 20%,
wherein the multilayer thermal barrier exhibits a pressure of less than 2,500 kPa when subjected to a compression of 55%, and
wherein a cold plate takes at least 500 seconds to reach 150° C. in a HCST test,
wherein the multilayer thermal barrier has the following 3-layer construction:
   a first thermally resistant layer,
   a thermally-insulating porous foam layer adjacent to the first thermally resistant layer, and
   a second thermally resistant layer adjacent to the thermally-insulating porous foam layer.
6. A multilayer thermal barrier, comprising
   one or more thermally-insulating porous foam layers,
   one or more thermally resistant layers disposed on the thermally-insulating porous foam layer,
wherein the thermally resistant layers comprise insulative particles,
wherein the multilayer thermal barrier exhibits a pressure of at least 30 kPa when subjected to a compression of 20%,
wherein the multilayer thermal barrier exhibits a pressure of less than 2,500 kPa when subjected to a compression of 55%, and
wherein a cold plate takes at least 500 seconds to reach 150° C. in a HCST test,
wherein the multilayer thermal barrier has the following 3-layer construction:
   a first thermally-insulating porous foam layer,
   a thermally resistant layer adjacent to the first thermally-insulating porous foam layer, and
   a second thermally resistant layer adjacent to the thermally resistant layer.
7. A multilayer thermal barrier according to any of the preceding embodiments, wherein the multilayer thermal barrier exhibits a pressure of at least 30 kPa when subjected to 1,000 cycles of mechanical cycling test.
8. A multilayer thermal barrier according to any of the preceding embodiments, wherein the multilayer thermal barrier exhibits a pressure of at least 30 kPa when subjected to a compression from 20% to 80% during a full load/unload cycle.
9. A multilayer thermal barrier according to any of the preceding embodiments, wherein the weight ratio of thermally-insulating porous foam layers to thermally resistant layers is from 20%-75%, 25%-75%, or 30%-75%, or 35%-75, or 40%-75%, or 20%-70%, 25%-70%, or 30%-70%, or 35%-70, or 40%-70%, or 20%-65%, 25%-65%, or 30%-65%, or 35%-65, or 40%-65%, or 20%-60%, 25%-60%, or 30%-60%, or 35%-60, or 40%-60%, or 20%-55%, 25%-55%, or 30%-55%, or 35%-55, or 40%-55%, in the multilayer thermal barrier.
10. A multilayer thermal barrier according to any of the preceding embodiments, wherein the multilayer thermal barrier exhibits a pressure of at least 35 KPa, or 40 KPa, or 50 KPa when subjected to a compression of 20%,
11. A multilayer thermal barrier according to any of the preceding embodiments, wherein the multilayer thermal barrier exhibits a pressure of less than 1,750 KPa, or 1,500 KPa, or 1,250 KPa, or 1,000 KPa, or 750 KPa when subjected to a compression of 60%.
12. A multilayer thermal barrier according to any of the preceding embodiments, wherein the multilayer thermal barrier has the following 3-layer construction:
   a first thermally resistant layer,
   a thermally-insulating porous foam layer immediately adjacent to the first thermally resistant layer, and
   a second thermally resistant layer immediately adjacent to the thermally-insulating porous foam layer.
13. A multilayer thermal barrier according to any of the preceding embodiments, wherein a cold plate takes at least: 100 seconds, or 200 seconds, or 300 seconds, or 400 seconds to reach 150° C. in a HCST test.
14. A multilayer thermal barrier according to any of the preceding embodiments, wherein a cold plate takes at least: 600 seconds, or 700 seconds, or 800 seconds, or 900 seconds, or 1000 seconds to reach 150° C. in a HCST test.
15. A multilayer thermal barrier according to any of the preceding embodiments, further comprising an organic encapsulation layer encapsulating the multilayer thermal barrier.
16. A multilayer thermal barrier according to any of the preceding embodiments, further comprising an organic encapsulation layer encapsulating the multilayer thermal barrier and wherein the organic encapsulation layer has at least one vent hole formed therethrough that is located and sized to allow gas contained within the multilayer thermal barrier to escape from the organic encapsulation, such that the structural integrity of the organic encapsulation layer is kept intact, during a thermal runaway event.
17. A multilayer thermal barrier according to any of the preceding embodiments, wherein the thermally-insulating porous foam layer comprises a material selected from the group consisting of silicone elastomers, fluorosilicone rubber, aromatic polyamides, polybenzimidazoles, polysulfides, polyimides, polysulfones, polyetherketones, flurorocarbons, polyisoprene, polybutadiene, polychloroprene, polyurethanes, polyolefins (in particular polyethylene, polypropylene and ethyl vinyl acetate), polystyrenes, and any combinations or mixtures thereof.
18. A multilayer thermal barrier according to any of the preceding embodiments, wherein the thermally-insulating porous foam layer comprises organopolysiloxane polymers.
19. A multilayer thermal barrier according to any of the preceding embodiments, wherein the thermally-insulating porous foam layer is obtainable from a curable and in-situ foamable precursor.
20. A multilayer thermal barrier according to any of the preceding embodiments, wherein the thermally-insulating porous foam layer is obtainable from addition curing a two-part organopolysiloxane composition.
21. A multilayer thermal barrier according to any of the preceding embodiments, wherein the thermally-insulating porous foam layer is obtainable from a precursor that comprises
   a) at least one organopolysiloxane compound A;
   b) at least one organohydrogenpolysiloxane compound B comprising at least two, in particular at least three hydrogen atoms per molecule;
   c) at least one hydroxyl containing compound C;
   d) an effective amount of a curing catalyst D, in particular a platinum-based curing catalyst; and
   e) optionally, a foaming agent.
22. A multilayer thermal barrier according to any of the preceding embodiments, wherein the thermally-insulating porous foam layer is obtainable from a precursor that comprises
   a) at least one organopolysiloxane compound A;
   b) at least one organohydrogenpolysiloxane compound B comprising at least two, in particular at least three hydrogen atoms per molecule;
   c) at least one hydroxyl containing compound C;
   d) an effective amount of a curing catalyst D, in particular a platinum-based curing catalyst; and
   e) optionally, a foaming agent,
wherein the at least one organopolysiloxane compound A has the following formula:

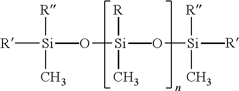

wherein:
R and R″, are independently selected from the group consisting of C₁ to C₃₀ hydrocarbon groups, and in particular R is an alkyl group chosen from the group consisting of methyl, ethyl, propyl, trifluoropropyl, and phenyl, and optionally R is a methyl group;
R′ is a C₁ to C₂₀ alkenyl group, and in particular R′ is chosen from the group consisting of vinyl, allyl, hexenyl, decenyl and tetradecenyl, and more in particular R′ is a vinyl group;
R″ is in particular an alkyl group such as a methyl, ethyl, propyl, trifluoropropyl, phenyl, and in particular R″ is a methyl group; and
n is an integer having a value in a range from 5 to 1000, and in particular from 5 to 100.
23. A multilayer thermal barrier according to any of the preceding embodiments, wherein the thermally-insulating porous foam layer is formed from a precursor that underwent foaming by a gaseous compound.
24. A multilayer thermal barrier according to any of the preceding embodiments, wherein the thermally-insulating porous foam layer has a density in a range from 200 to 500 kg/m³.
25. A multilayer thermal barrier according to any of the preceding embodiments, wherein the thermally-insulating porous foam layer has a heat transfer time to 150° C. of 140 to 200 seconds in a HCST test.
26. A multilayer thermal barrier according to any of the preceding embodiments, wherein the thermally-insulating porous foam layer is capable of undergoing a ceramization process at a temperature in a range from 200° C. to 600° C.
27. A multilayer thermal barrier according to any of the preceding embodiments, wherein the thermally-insulating porous foam layer comprises a nonflammable filler material which is in particular selected from the group of inorganic fibers, in particular from the group consisting of mineral fibers, mineral wool, silicate fibers, ceramic fibers, glass fibers, carbon fibers, graphite fibers, asbestos fibers, aramide fibers, and any combinations or mixtures.
28. A multilayer thermal barrier according to any of the preceding embodiments, wherein the thermally-insulating porous foam layer a filler material selected from aluminum trihydroxide (A TH), magnesium hydroxide (MDH), Huntite-Hydromagnesite, talc, clay, Boron based flame retardants, molybdenum compounds, tin compounds, antimony compounds, expandable graphites, gypsum, calcium carbonates, carbide fillers, metals, metal oxides, sulfates, sulfides, silicates, glasses, titanates and any combination or mixtures thereof.
29. A multilayer thermal barrier according to any of the preceding embodiments, wherein the thermally resistant layer consists essentially of:
   a single-layer of a nonwoven fibrous thermal insulation comprising a fiber matrix of inorganic fibers, thermally insulative inorganic particles dispersed within the fiber matrix, and a binder dispersed within the fiber matrix so as to hold together the fiber matrix.
30. A multilayer thermal barrier according to any of the preceding embodiments, wherein the thermally resistant layer consists comprises:
   a layer of a nonwoven fibrous thermal insulation comprising a fiber matrix of inorganic fibers, thermally insulative inorganic particles of irreversibly expanded intumescent material dispersed within the fiber matrix, and a binder dispersed within the fiber matrix so as to hold together the fiber matrix.
31. A multilayer thermal barrier according to any of the preceding embodiments, wherein the thermally resistant layer contains an amount of fiber shot in the range of from about 3% up to about 60% by weight of the amount of inorganic fibers in the layer of nonwoven fibrous thermal insulation
32. A multilayer thermal barrier according to any of the preceding embodiments, wherein the thermally resistant layer contains an amount of fiber shot in the range of from about 3% up to about 60% by weight of the amount of inorganic fibers in the layer of nonwoven fibrous thermal insulation.
33. A multilayer thermal barrier according to any of the preceding embodiments, wherein the thermally resistant layer an amount of thermally insulative inorganic particles in the range of from as low as about 10% up to as high as about 60%, by weight of the thermally resistant layer.
34. A multilayer thermal barrier according to any of the preceding embodiments, wherein the thermally resistant layer has an uncompressed thickness in the range of from about 2 mm up to 10.0 mm.
35. A multilayer thermal barrier according to any of the preceding embodiments, wherein the thermally resistant layer has an installed thickness in the range of from about 0.5 mm up to about 5 mm
36. A multilayer thermal barrier according to any of the preceding embodiments, wherein the thermally resistant layer contains an amount of organic binder in the range of from as low as about 2.5% up to as high as about 10.0%, by weight of the thermally resistant layer.
37. A multilayer thermal barrier according to any of the preceding embodiments, wherein the thermally resistant layer has a basis weight in the range of from as low as about 250 g/m² at about a 1 mm gap, and up to as high as about 1000 g/m² at about a 2 mm gap.
38. A multilayer thermal barrier according to any of the preceding embodiments, wherein the thermally resistant layer has an uncompressed basis weight in the range of from about 250 g/m² up to about 400 g/m².
39. A multilayer thermal barrier according to any of the preceding embodiments, wherein the thermally resistant layer comprises particles of one or any combination of the materials selected from the group consisting of inorganic aerogel, xerogel, hollow or porous ceramic microspheres, unexpanded vermiculite, irreversibly or permanently expanded vermiculite, fumed silica, otherwise porous silica, irreversibly or permanently expanded or unexpanded perlite, pumicite, irreversibly or permanently expanded clay, diatomaceous earth, titania and zirconia.
40. A multilayer thermal barrier according to any of the preceding embodiments, wherein the thermally resistant layer comprises inorganic fibers in a fiber matrix, and the inorganic fibers are selected from the group of fibers consisting of alkaline earth silicate fibers, refractory ceramic fibers (RCF), polycrystalline wool (PCW) fibers, basalt fibers, glass fibers and silicate fiber
41. A multilayer thermal barrier according to any of the preceding embodiments, wherein the thermally resistant layer passes a UL94 V0 test.
42. A multilayer thermal barrier according to any of the preceding embodiments, wherein the thermally resistant layer comprises a layer of a nonwoven fibrous thermal insulation comprising a fiber matrix of inorganic fibers, thermally insulative inorganic particles of irreversibly expanded intumescent material dispersed within the fiber matrix, and a binder dispersed within the fiber matrix so as to hold together the fiber matrix,
   wherein the expanded intumescent material has been irreversibly expanded in the range of from at least about 10% up to 100% of its expandability.
43. A multilayer thermal barrier according to any of the preceding embodiments, wherein the thermally resistant layer comprises a layer of a nonwoven fibrous thermal insulation comprising a fiber matrix of inorganic fibers, thermally insulative inorganic particles of irreversibly expanded intumescent material dispersed within the fiber matrix, and a binder dispersed within the fiber matrix so as to hold together the fiber matrix,
   wherein the inorganic thermally insulative particles comprise particles of irreversibly expanded vermiculite.
44. A multilayer thermal barrier according to any of the preceding embodiments, wherein the inorganic thermally insulative particles comprise particles of fumed silica,
45. A battery module comprising a multilayer thermal barrier according to any of the preceding embodiments.
46. A battery module comprising a multilayer thermal barrier according to any of the preceding embodiments, further comprising:
   a plurality of battery cells disposed in a housing; and
   wherein the battery cells are lined up in a row, with one multilayer thermal barrier being disposed between adjacent battery cells.

### EXAMPLES

The present disclosure is further illustrated by the following examples. These examples are merely for illustrative purposes only and are not meant to be limiting on the scope of the appended claims. Where applicable, brand names and trademarked names are shown in all capital letters and/or numbers.

### Test Methods

1) Compression Test

The compression test is performed using a tensile tester from Zwick in compression mode. The sample has a diameter of 50.8 mm and a thickness >1000 micrometers. The test was performed at 23° C. The upper plate of the compression tester was moved with a speed of 1 mm/min until a maximum force of 2 MPa is reached. Then, the upper plate was moved up back to the starting position with the same speed of 1 mmm/min for a full load/unload cycle. The compression force (in kPa) required to reach various compression values were recorded.
2) Coating Weight

The coating weight of the polymeric foam layers is measured by weighing a sample of 100 cm² cut out of the sample layer using a circle cutter. The coating weight is then converted in g/m².
3) Thickness

The thickness of the polymeric foam layers is measured using a thickness gauge with a minimum foot area of 650 mm². The pressure of the gauge foot was held to a maximum of 725 Pa.
4) Hot-side/Cold-side Test (HCST)

In a 10 kN tensile test machine (obtained from ZWICKROELL of Ulm, Germany), a top platen was heated to 800° C. and a sample was placed on a bottom platen with a thermocouple embedded set at ambient temperature. A heat shield was used to cover the sample to ensure that it stayed at ambient temperature. Before conducting the test, the thickness of the sample was measured under a load of 4.9 kPa. The heat shield was then removed, and the upper platen was lowered to the thickness with a closing rate of 250 mm/min. At this point the test was started at 0 seconds test time. Then, the closing rate was reduced to 2 mm/min and the upper platen was lowered with pressure held at 1 MPa. The time the sample took reach a temperature of 150° C. (302° F.), designated t (150° C.), was recorded. As will be shown in the results, the cold plate did not reach a temperature of 150° C. with some of the samples tested within a specified time period (e.g., 500 sec). In those cases, the result was recorded as taking more than 500 seconds for the cold plate to reach 150° C., even though the cold plate did not reach 150° C. within the allotted time. The bottom plate was made of stainless steel having a heat capacity of 450 J/(kg*K) and a thickness of 30 mm. The upper hot plate and the bottom cold plate had the same length and width and a weight of 1260 g each.
5) Mechanical Cycling Test

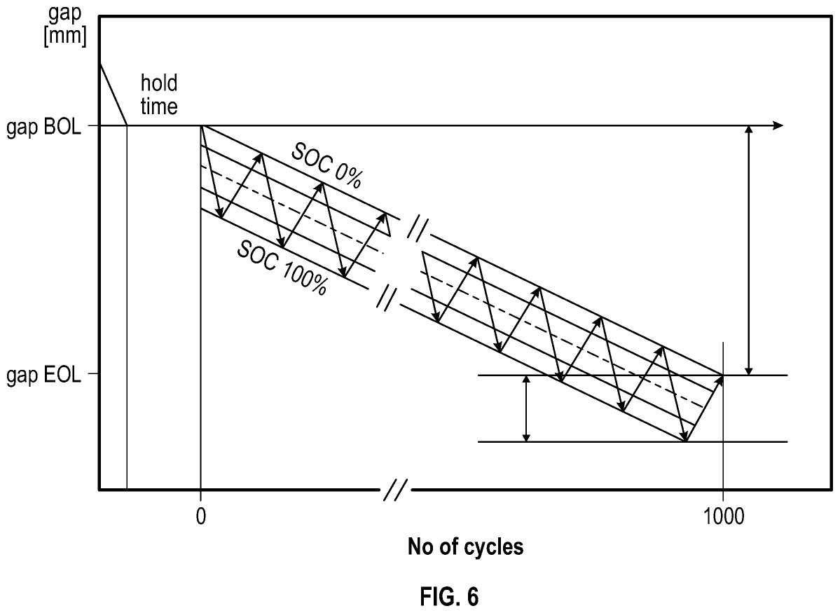

The cyclic compression test was performed using a material tester from ZWICKROELL in compression mode. Samples had a diameter of 50.8 mm and a thickness greater than 1000 micrometers. The test was performed at ambient temperature (i.e., about 23° C.). The upper plate of the compression tester was moved with a speed of 25 mm/min until a force of 0.15 MPa was reached. Then, the upper plate was moved at a rate of 1 mm/min frequently up and down until the requested number of cycles was reached. The cycling amplitude represented cell expansion and retraction when charging and discharging (i.e., cell breathing). Maximum amplitude occurred when the battery is completely discharged (state of charge SOC equals 0%) and completely charged (100% equals SOC). Refer to FIG. 6 (BOL indicates beginning of life and EOL indicates end of life). A full amplitude height is typically 0.5 mm and is dependent on the actual cell chemistry. Additionally, the continuous irreversible cell swelling was added incrementally with every cycle representing irreversible changes at the Li-ion electrodes. Typical irreversible swelling is about 2 to 8% of the cell thickness and cell chemistry. Thus, irreversible swelling is between about 0.5 mm and about 2.0 mm. The minimum and maximum pressure per cycle was recorded and reported.

### Porous Foam Constructions

### Raw Materials

The following raw materials were used in the examples or can be used as replacement, or in combination with, components that were used in the examples:
DOWSIL 3-8209 is a two-part room temperature curable silicone rubber foam formulations commercially available under the trade designation DOWSIL obtained from the Dow Chemical Company of Midland, MI, United States.
DOWSIL 3-8235 is another two-part room temperature curable silicone rubber foam formulations commercially available under the trade designation DOWSIL obtained from the Dow Chemical Company of Midland, MI, United States.
BLUESIL RT Foam 3242 is an open cell silicone foam available under the trade designation BLUESIL from Elkem Silicones, Oslo, Norway.
COATFORCE CF30 is a silicate fiber and COATFORCE CF50 is a mineral fiber both obtained from Rockwool B.V., The Netherlands.
MARTINAL OL-104 LEO is a fine aluminum trihydroxide (ATH) with a d50 in the range from about 1.7 to about 2.1 micrometer obtained from Martinswerk GmBH of Bergheim, Germany available under the trade designation MARTINAL OL-104 LEO.
IMERSEAL 74S is a surface treated calcium carbonate available under the trade designation IMERSEAL obtained from Imerys S.A., Paris, France.

### Porous Foam Preparatory Examples

The exemplary hand-made porous foam layers were prepared according to the following procedure:

The identified materials (refer to Table 1) in weight parts were added to each part A and B of a silicone foam using a SPEEDMIXER at a speed of 1500 RPM for 120 seconds. CF50 was mixed with OL-104 LEO. The quantities of materials in weight parts as identified in Table 1 were added to a 200 mL two-part cartridge system from Adchem GmbH with a volumetric mixing ratio of 1:1 (200 mL F System cartridge). The two-part silicone system was mixed with a static mixer (MFH 10-18T) using a dispensing gun at 4 bar air pressure. After releasing 100 g of the mixed silicone in a jar, the mixture was additionally homogenized by hand using a wooden spatula for 10 seconds. The mixture was then coated with a knife coater with a gap thickness of 600 micrometers (PE1 and PE2) between two layers of Hostaphan RN 50/50 solid film. The obtained sheet began to expand, and the reaction was completed by putting the sheet in a forced air oven at 80° C. for ten minutes. Thickness, coating weight, density, thermal conductivity, and compression testing were conducted, and the results are also contained in Table 1.

TABLE 1
Foam Composition Data and Test Results

| | | PE1 | PE2 |
|---|---|---|---|
| Part A | DOWSIL 3-8209 | 100 | 0 |
| | BLUESIL RT FOAM 3242 | 0 | 100 |
| | MARTINAL OL-104 LEO | 73 | 67.5 |
| | COATFORCE CF50 | 9 | 10 |
| Part B | DOWSIL 3-8209 | 100 | 0 |
| | BLUESIL RT FOAM 3242 | 0 | 100 |
| | IMERSEAL 74S | 67 | 76 |
| Results | Thickness (μm) | 2556 | 2500 |
| | Coating Weight (g/m²) | 920 | 925 |
| | Density (kg/m³) | 360 | 370 |
| | Thermal conductivity | 0.06 | 0.06 |
| | (W/m · K) | | |
| | Compression force @ 40% | 194 | 214 |
| | deformation (kPa) | | |
| | Compression force @ 60% | 654 | 662 |
| | deformation (kPa) | | |

### Thermally-Resistant Layer Preparatory Examples

TABLE 2
Materials

| Material | Description | Source |
|---|---|---|
| EAF68 | Aqueous polymer dispersed pressure sensitive adhesive | Wacker Chemie AG, |
| | available under the designation VINNAPAS EAF 68 | Munchen, Germany |
| | Vinyl Acetate Ethylene | |
| SW+ | Alkaline earth silicate fibers with a mean fiber diameter | Morgan Advanced |
| | of 2.5-3.4 micrometers available under the trade | Materials, Windsor, |
| | designation “SUPERWOOL PLUS” | United Kingdom |
| FS | Fumed silica, available under the trade designation | Cabot Corporation, |
| | CAB-O-SIL | Alpharetta GA, United |
| | | States |
| VERM | Vermucilite, 0.3-0.8 mm particle size | Cometals, Inc, New |
| | | York, NY, United |
| | | States |

The ‘General Procedure for Preparing Fibrous Sheet’ as described in U.S. Patent Application No. 2010/0115900 with material substitution as identified in Table 3 was followed. Tap water (3 liters, 18° C.) and 60 grams (g) of inorganic fibers and cleaned to a shot content of less than 50 percent by weight) were added to a GT800 Classic blender (obtained from Rotor Lips Ltd, Uetendorf, Switzerland). The blender was operated on low speed for five seconds. The resultant slurry was rinsed into a RW16 mixing container equipped with a paddle mixer (obtained from IKA-Werke GmbH, Staufen, Germany) using one liter of tap water (18° C.). The slurry was diluted with an additional one liter of tap water (18° C.). The diluted slurry was mixed at medium speed to keep solids suspended. Defoaming agent (obtained under the trade designation “FOAMASTER 111” (0.3 g) from Henkel, Edison, N.J.) and ethylene-vinyl acetate terpolymer latex (obtained under the trade designation “AIRFLEX 600BP” (6.0 g, 55 percent by weight solids) from Air Products were added. Flocculent is added dropwise in amounts as indicated in Table 3. Thermally insulative particles were then added as indicated in Table 3. The mixer speed was increased, and mixing continued for from 1 to 5 minutes. The paddle mixer was removed, and the slurry was poured into a 20 cm×20cm (8 inches×8 inches) sheet former (obtained from Williams Apparatus Co, Watertown, NY, United States) and drained. The surface of the drained sheet was rolled with a rolling pin to remove excess water. Then, the sheet was pressed between blotter papers at a surface pressure of 90-97 kPa (13-14 psi) for five minutes. The sheet was then dried at 150° C. in a forced air oven for 10-15 minutes and allowed to equilibrate overnight while exposed to the ambient atmosphere. The thickness and basis weight of the samples were measured at a constant pressure of 4.9 kPa and are recorded in Table 4.

TABLE 3
Thermally-Resistant Layer Compositions (weight percent)

| | SW+ | EAF68 | FS | VERM |
|---|---|---|---|---|
| PE3 | 50 | 5 | 0 | 45 |
| PE4 | 50 | 5 | 45 | 0 |

TABLE 4
Thermally-Resistant Layer Parameters

| | Thickness | Basis Weight |
|---|---|---|
| | (mm) | (gsm) |
| PE3 | 4.17 | 643 |
| PE4 | N/A | 1200 |

### Multilayer Thermal Barrier Constructions

### Comparative Example 1

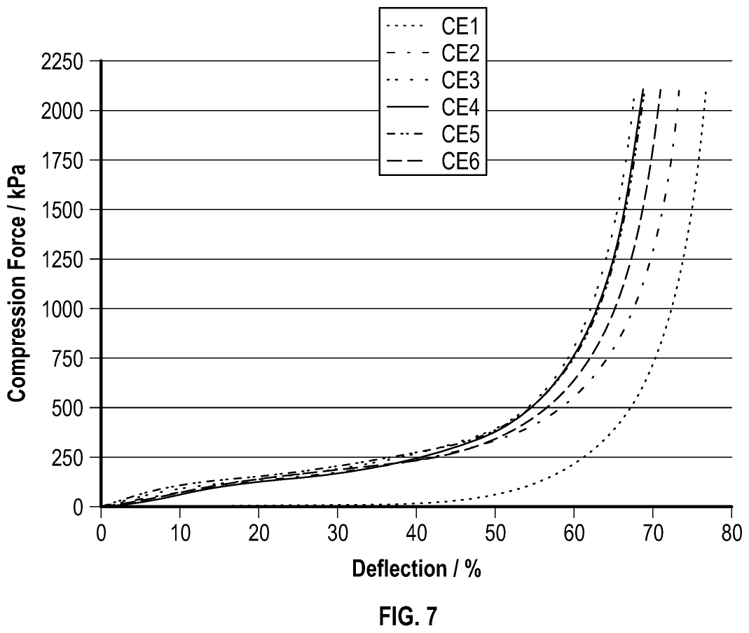

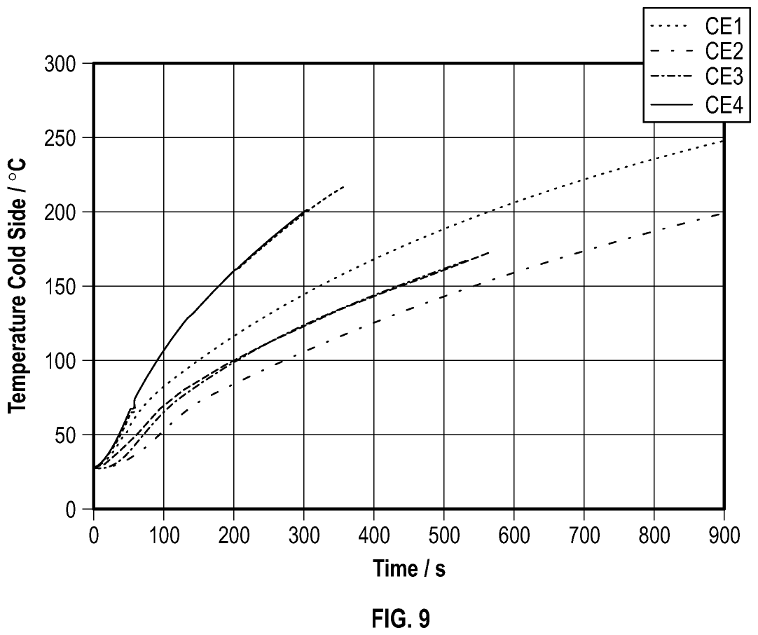

A multilayer thermal barrier article was assembled by creating a three-layer stack of PE3. The article underwent compression and HCST testing, and the results are represented in Table 5 and FIGS. 7 and 9.

### Comparative Example 2

A multilayer thermal barrier article was assembled by creating a three-layer stack of PE1. The article underwent compression and HCST testing, and the results are represented in Table 5 and FIGS. 7 and 9.

### Comparative Example 3

A multilayer thermal barrier article was assembled by creating a two-layer stack of PE2 and a 160-micrometer thick KAPTON polyimide film (obtained from DuPont, Wilmington, DE, United States). PE2 was the base layer and polyimide film was laminated to the top. The article underwent compression and HCST testing, and the results are represented in Table 5 and FIGS. 7 and 9.

### Comparative Example 4

A multilayer thermal barrier article was assembled by creating a two-layer stack of PE2 and a 170 g/m2 polyaramide fiber fabric (obtained from DuPont, Wilmington, DE, United States). PE2 was the base layer and polyaramide fiber fabric was laminated to the top. The article underwent compression and HCST testing, and the results are represented in Table 5 and FIGS. 7 and 9.

### Comparative Example 5

A multilayer thermal barrier article was assembled by creating a three-layer stack of PE2 and two 160-micrometer thick KAPTON polyimide films (obtained from DuPont, Wilmington, DE, United States). PE2 was the core layer with polyimide films laminated to the top and bottom. The article underwent compression and HCST testing, and the results are represented in Table 5 and FIGS. 7 and 9.

### Comparative Example 6

A multilayer thermal barrier article was assembled by creating a three-layer stack of PE2 and two 170 g/m2 polyaramide fiber fabrics (obtained from DuPont, Wilmington, DE, United States). PE2 was the core layer with polyaramide fiber fabrics laminated to the top and bottom. The article underwent compression and HCST testing, and the results are represented in Table 5 and FIGS. 7 and 9.

### Example 1

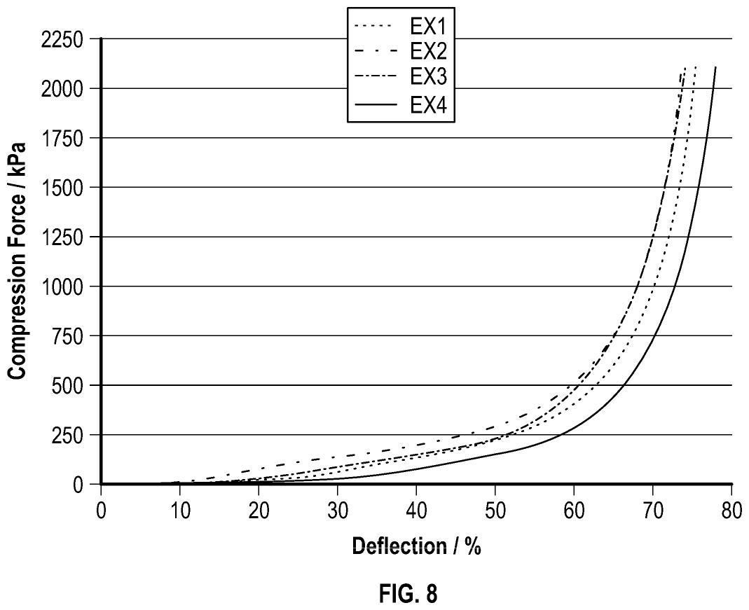

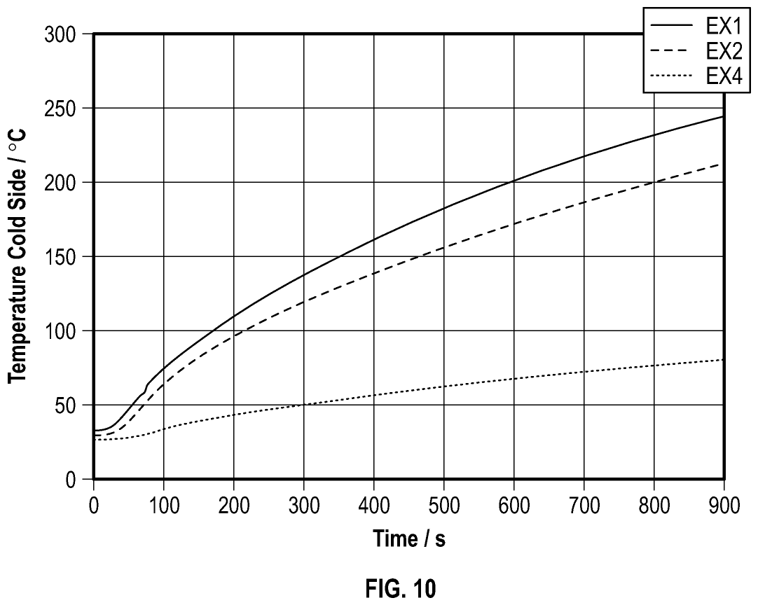

A multilayer thermal barrier article was assembled by creating a three-layer stack of PE1 and PE3. PEI was the core layer with PE4 layers laminated to the top and bottom. The article underwent compression and HCST testing, and the results are represented in Table 5 and FIGS. 8 and 10.

### Example 2

A multilayer thermal barrier article was assembled by creating a three-layer stack of PE1 and PE3. PEI was the core layer with PE2 layers laminated to the top and bottom. The article underwent compression and HCST testing, and the results are represented in Table 5 and FIGS. 8 and 10.

### Example 3

A multilayer thermal barrier article was assembled by creating a three-layer stack of PE2 and PE4. PE4 was the core layer with PE2 layers laminated to the top and bottom. The article underwent compression and HCST testing, and the results are represented in Table 5 and FIGS. 8 and 10.

### Example 4

A multilayer thermal barrier article was assembled by creating a two-layer stack of PE2 and PE4. PE4 was the base layer and the PE2 layer was laminated to the top. The article underwent compression and HCST testing, and the results are represented in Table 5 and FIGS. 7-10.

TABLE 5
Compression and Hot-Side/Cold-Side Test Results

| | HCST | Compression Force (kPa) | | | | | |
|---|---|---|---|---|---|---|---|
| | t(150° C.) sec | @ 20% | @ 30% | @ 40% | @ 50% | @ 60% | @ 70% |
| CE1 | 317 | 3 | 7 | 18 | 61 | 209 | 710 |
| CE2 | 529 | 134 | 175 | 233 | 332 | 547 | 1286 |
| CE3 | 177 | 129 | 177 | 250 | 391 | 802 | N/A |
| CE4 | 177 | 124 | 171 | 242 | 376 | 748 | N/A |
| CE5 | 427 | 152 | 200 | 265 | 388 | 748 | N/A |
| CE6 | 431 | 131 | 172 | 230 | 342 | 631 | 1780 |
| EX1 | 348 | 13 | 58 | 128 | 217 | 407 | 1011 |
| EX2 | 459 | 75 | 134 | 191 | 292 | 519 | 1285 |
| EX3 | >7200 | 25 | 81 | 140 | 235 | 472 | 1275 |
| EX4 | >940 | 8 | 26 | 75 | 149 | 292 | 747 |

1. A multilayer thermal barrier, comprising
one or more thermally-insulating porous foam layers,
one or more thermally resistant layers disposed on the thermally-insulating porous foam layer,
wherein a thermally-insulating porous foam layer alternates with a thermally resistant layer,
wherein the thermally resistant layers comprise insulative particles,
wherein the multilayer thermal barrier exhibits a pressure of at least 30 kPa when subjected to a compression of 20%,
wherein the multilayer thermal barrier exhibits a pressure of less than 2,500 kPa when subjected to a compression of 55%, and
wherein a cold plate takes more than 500 seconds to reach 150° C. in a HCST test.

2. A multilayer thermal barrier according to claim 1, wherein the multilayer thermal barrier exhibits a pressure of at least 30 kPa when subjected to 1,000 cycles of mechanical cycling test.

3. A multilayer thermal barrier according to claim 1, wherein the weight ratio of thermally-insulating porous foam layers to thermally resistant layers is from 20%-75% in the multilayer thermal barrier.

4. A multilayer thermal barrier according to claim 1, wherein the multilayer thermal barrier has the following 3-layer construction:
a first thermally resistant layer,
a thermally-insulating porous foam layer immediately adjacent to the first thermally resistant layer, and
a second thermally resistant layer immediately adjacent to the thermally-insulating porous foam layer.

5. A multilayer thermal barrier according to claim 1, further comprising an organic encapsulation layer encapsulating the multilayer thermal barrier.

6. A multilayer thermal barrier according to claim 1, wherein the thermally-insulating porous foam layer comprises a material selected from the group consisting of silicone elastomers, fluorosilicone rubber, aromatic polyamides, polybenzimidazoles, polysulfides, polyimides, polysulfones, polyetherketones, flurorocarbons, polyisoprene, polybutadiene, polychloroprene, polyurethanes, polyolefins (in particular polyethylene, polypropylene and ethyl vinyl acetate), polystyrenes, and any combinations or mixtures thereof.

7. A multilayer thermal barrier according to claim 1, wherein the thermally-insulating porous foam layer comprises organopolysiloxane polymers.

8. A multilayer thermal barrier according to claim 1, wherein the thermally-insulating porous foam layer has a heat transfer time to 150° C. of 140 to 200 seconds in a HCST test.

9. A multilayer thermal barrier according to claim 1, wherein the thermally resistant layer consists comprises:
a layer of a nonwoven fibrous thermal insulation comprising a fiber matrix of inorganic fibers, thermally insulative inorganic particles of irreversibly expanded intumescent material dispersed within the fiber matrix, and a binder dispersed within the fiber matrix so as to hold together the fiber matrix.

10. A multilayer thermal barrier according to claim 1, wherein the thermally resistant layer contains an amount of fiber shot in the range of from about 3% up to about 60% by weight of the amount of inorganic fibers in the layer of nonwoven fibrous thermal insulation.

11. A multilayer thermal barrier according to any of the preceding claims, wherein the thermally resistant layer an amount of thermally insulative inorganic particles in the range of from as low as about 10% up to as high as about 60%, by weight of the thermally resistant layer.

12. A multilayer thermal barrier according to claim 1, wherein the thermally resistant layer contains an amount of organic binder in the range of from as low as about 2.5% up to as high as about 10.0%, by weight of the thermally resistant layer.

13. A multilayer thermal barrier according to claim 1, wherein the thermally resistant layer comprises a layer of a nonwoven fibrous thermal insulation comprising a fiber matrix of inorganic fibers, thermally insulative inorganic particles of irreversibly expanded intumescent material dispersed within the fiber matrix, and a binder dispersed within the fiber matrix so as to hold together the fiber matrix,
wherein the expanded intumescent material has been irreversibly expanded in the range of from at least about 10% up to 100% of its expandability.

14. A multilayer thermal barrier according to claim 1, wherein the inorganic thermally insulative particles comprise particles of fumed silica,

15. A battery module comprising a multilayer thermal barrier according to claim 1.
